(19) United States
(12) Patent Application Publication
(10) Pub. No.: US 2023/0230044 A1
(43) Pub. Date: Jul. 20, 2023

(54) CALENDAR UPDATE USING TEMPLATE SELECTIONS

(71) Applicant: MICROSOFT TECHNOLOGY LICENSING, LLC, Redmond, WA (US)

(72) Inventor: Samuel Robert CUNDALL, Mercer Island, WA (US)

(21) Appl. No.: 17/566,134

(22) Filed: Dec. 30, 2021

(51) Int. Cl. G06Q 10/10

(52) U.S. Cl. CPC G06Q 10/1095

(57) ABSTRACT

Graphically movable objects are rendered that automatically populates properties of the meeting with a predetermined meeting type and a duration. In response to placement of a selected graphically movable object on a calendar, a start time for a scheduled meeting is determined. The scheduled meeting is added to the calendar having the start time and the predetermined meeting type.

### BACKGROUND

Some computing systems provide interactive and collaborative environments that facilitate communication between two or more participants. Such systems may include a calendaring program configured to schedule and manage meetings and appointments. Although existing calendaring programs provide many features for scheduling meetings, inefficient interaction with calendaring programs can be detrimental to user productivity and use of computing resources. When calendaring applications do not optimize user engagement and ease/efficiency of updates, production loss and inefficiencies can result when a participant is unable to quickly and easily create and manage events on their calendar. For example, some calendaring applications may require that users open calendar items and perform a number of menu-driven tasks to create a new meeting or delete a meeting. Thus, when a participant needs to interact with a calendar to manage a meeting, the participant must find and enable the appropriate features to open up a new or existing meeting and provide a number of actions to populate the meeting. It is with respect to these considerations and others that the disclosure made herein is presented.

### SUMMARY

Many calendar applications require schedule information to be modified in a static and linear manner that requires multiple user inputs of various types. For example, in order to schedule a new meeting, a user must find and open calendars of potential attendees, find a free spot which may sometimes require deleting or move a meeting. The user must then populate a number of data fields to enter details for the meeting. By the use of the technologies described herein is a new way to schedule, move, and cancel meetings in a calendar application. Various embodiments provide a way for a manage meetings in a calendar view via drag-n-drop selection from template objects that include meeting types and durations.

The disclosed embodiments enable a more efficient and intuitive way to create and update calendar information that includes the use of visual objects and interactive inputs. This enables more accurate and predictable entry and modification of calendar entries, while avoiding erroneous or undesired entries due to, for example, double-booking appointments or booking back-to-back meetings. The disclosed embodiments further facilitate more efficient and productive meeting scheduling, for example, by facilitating the scheduling of meetings with time prior to prepare for selected meetings, allowing time after meetings to complete follow-up actions, and readily differentiating between meetings (e.g., large or organizational meetings vss smaller or working meetings).

The present disclosure also describes the underlying architecture, systems, and data objects that enable and support calendar user interface (UI) functionality that allows the use of graphically movable objects that, when associated with a meeting on a calendar, automatically populates properties of the meeting with a predetermined meeting type and a duration. The architecture, systems, and data objects allow for gesture inputs that indicate placement of a selected graphically movable object on a calendar rendering on UI. The start time for a scheduled meeting may be determined based on the proximity of the placement of the selected graphically movable object relative to one of the time slots on the calendar that indicate the start time. The calendar may be associated with a data structure that stores data for meetings on the calendar, and the data structure may be populated with one or more properties for the scheduled meeting. Properties for the scheduled meeting may be populated based on the start time, the predetermined meeting type, and the duration associated with the selected graphically movable object. In some embodiments, the data structure can be a multidimensional data structure that tracks on a per-meeting basis. The graphically movable object may be associated with a data object that includes a meeting type and meeting duration.

Among many benefits provided by the technologies described herein, a user’s interaction with a device may be improved, which may reduce the number of inadvertent inputs, reduce the consumption of processing resources, and mitigate the use of network resources. Such benefits may be realized through the use of, for example, using the cursor, touch input, or the arrow keys to set up and move meetings, categorizing meetings based on shapes that define duration and type, or changing the orientation of a template object to change a meeting type or duration.

Other technical effects other than those mentioned herein can also be realized from implementations of the technologies disclosed herein. Existing systems for allowing users to manually interact with calendar items typically require users to perform a number of tasks. The user can spend a considerable amount of time searching through available calendar items to find and change settings, invoke additional applications to perform functions that are not native to the calendar application, and to find content that is associated with the scheduled activity. This can lead to extensive and unnecessary consumption of computing resources.

The examples described herein may be provided within the context of collaborative environments, e.g., scheduled calendar events, group meetings, live broadcasts, etc. For illustrative purposes, it can be appreciated that a computer managing a calendaring environment involves any type of computer that can access a user’s calendar data and manage a communication session where two or more computers are sharing data. For illustrative purposes, an “event” is a particular instance of a communication session, which may have a start time, an end time, and other parameters for controlling how data is shared and displayed to users participating in the communication session.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is an example user interface illustrating aspects of a calendaring environment for the embodiments disclosed herein.

FIG. 2A through FIG. 2M illustrate example displays, according to various embodiments disclosed herein.

FIG. 3A and FIG. 3B illustrate example displays, according to various embodiments disclosed herein.

FIG. 4 illustrates an example system diagram in accordance with an embodiment.

FIG. 5 illustrates an example system diagram in accordance with an embodiment.

FIG. 6 illustrates an example system diagram in accordance with an embodiment.

FIG. 7 is a computing system diagram showing aspects of an illustrative operating environment for the technologies disclosed herein;

FIG. 8 is a computing device diagram showing aspects of the configuration and operation of a device that can implement aspects of the disclosed technologies, according to one embodiment disclosed herein.

FIG. 9 is a computing system diagram showing aspects of an illustrative operating environment for the technologies disclosed herein;

FIG. 10 illustrates aspects of a routine, according to one embodiment disclosed herein;

FIG. 11 illustrates aspects of a routine, according to one embodiment disclosed herein;

FIG. 12 is a computing system diagram showing aspects of an illustrative operating environment for the technologies disclosed herein;

FIG. 13 is a computing device diagram showing aspects of the configuration and operation of a device that can implement aspects of the disclosed technologies, according to one embodiment disclosed herein.

### DETAILED DESCRIPTION

The following Detailed Description describes an improved interface for viewing and interacting with calendar events that are rendered in a representation of a calendar. Various embodiments are disclosed that enable productive management of past, present, and future calendared activity for users. In some embodiments, a calendar application may provide a calendar view with template selections that provide options selectable by a user. Each option may be associated with a specific type and length of time, and the user may drag and drop the selection to a specific time slot to block a time for the meeting type corresponding to the selected template. Such features can result in more efficient use of computing resources such as processor cycles, memory, network bandwidth, and power, as compared to previous solutions relying upon inefficient interaction with a rendered calendar environment and objects within the rendered calendar environment. Technical benefits other than those specifically described herein might also be realized through implementations of the disclosed technologies.

Calendar objects are typically representations of scheduled events in a calendaring application that is configured to provide an electronic representation of a calendar. The representation may include a calendar showing dates and days of the week and a list of appointments. The calendaring application may be a local application designed for individual use or may be a networked application that allows for the sharing of calendar information in an interactive and collaborative environment. Examples of calendaring software include WINDOWS LIVE CALENDAR, GOOGLE CALENDAR, or MICROSOFT OUTLOOK.

A scheduled and networked meeting represents one popular form of electronic collaboration that utilizes an interactive application program (e.g., CISCO WEBEX provided by CISCO SYSTEMS, Inc. of San Jose, CA, GOTOMEETING provided by CITRIX SYSTEMS, INC. of Santa Clara, CA, ZOOM provided by ZOOM VIDEO COMMUNICATIONS of San Jose, CA, GOOGLE HANGOUTS by ALPHABET INC. of Mountain View, CA, SKYPE, and SKYPE FOR BUSINESS and TEAMS provided by MICROSOFT CORPORATION, of Redmond, WA) to facilitate communication between two or more participants. Participants of a communication session in a networked meeting are able to exchange live video, audio, and other types of content to view, hear, and otherwise share information. Various types of computing devices can be utilized to participate in networked meetings including, but not limited to, smartphones, tablet computing devices, settop boxes, smart televisions, video game systems, and AR, VR, and MR/XR devices.

Many calendaring applications present schedule information in a static format. Details of a calendar event may not be updated in a dynamic and interactive manner and calendar information may not be readily added or updated unless the calendar event is opened and populated with various information through manual inputs or a series of input operations. Various embodiments are disclosed for implementing an improved interface for viewing and interacting with calendar objects of a calendaring application. In one embodiment, an interactive calendar surface is disclosed that is operable to facilitate a user’s interaction with the content of a calendar event. The enabled user interactions may include ways to schedule, move, and cancel meetings in a calendar application. Various embodiments provide a way for a user to select a time in a calendar view via drag-n-drop selection from template objects that include meeting types and durations. By the use of the technologies described herein, information for a calendar event is presented in a dynamic format that allows for timely and useful information to be added or updated within the calendar view.

In some embodiments, the interactive calendar may enable a more efficient and intuitive way to create and update calendar information that includes the use of visual objects and interactive inputs. Among many benefits provided by the technologies described herein, a user’s interaction with a device may be improved, which may reduce the number of inadvertent inputs, reduce the consumption of processing resources, and mitigate the use of network resources. Other technical effects other than those mentioned herein can also be realized from implementations of the technologies disclosed herein.

Turning now to the figures (which might be referred to herein as a “FIG.” or “FIGS.”), additional details will be provided regarding an improved calendar interface disclosed herein with reference to the accompanying drawings. The figures show, by way of illustration, specific configurations or examples. Like numerals represent like or similar elements throughout the FIGS. In the FIGS., the left-most digit(s) of a reference number generally identifies the figure in which the reference number first appears. References made to individual items of a plurality of items can use a reference number with another number included within a parenthetical (and/or a letter without a parenthetical) to refer to each individual item. Generic references to the items might use the specific reference number without the sequence of letters. The drawings are not drawn to scale.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings. Furthermore, the claimed subject matter is not limited to implementations that solve any or all disadvantages noted in any part of this disclosure.

It should be appreciated that various aspects of the subject matter described briefly above and in further detail below can be implemented as a hardware device, a computer-implemented method, a computer-controlled apparatus or device, a computing system, or an article of manufacture, such as a computer storage medium. While the subject matter described herein is presented in the general context of program modules that execute on one or more computing devices, those skilled in the art will recognize that other implementations can be performed in combination with other types of program modules. Generally, program modules include routines, programs, components, data structures, and other types of structures that perform particular tasks or implement particular abstract data types.

Those skilled in the art will also appreciate that aspects of the subject matter described herein can be practiced on or in conjunction with other computer system configurations beyond those specifically described herein, including multiprocessor systems, microprocessor-based or programmable consumer electronics, AR, VR, and MR devices, video game devices, handheld computers, smartphones, smart televisions, self-driving vehicles, smart watches, e-readers, tablet computing devices, special-purpose hardware devices, network appliances, and the others.

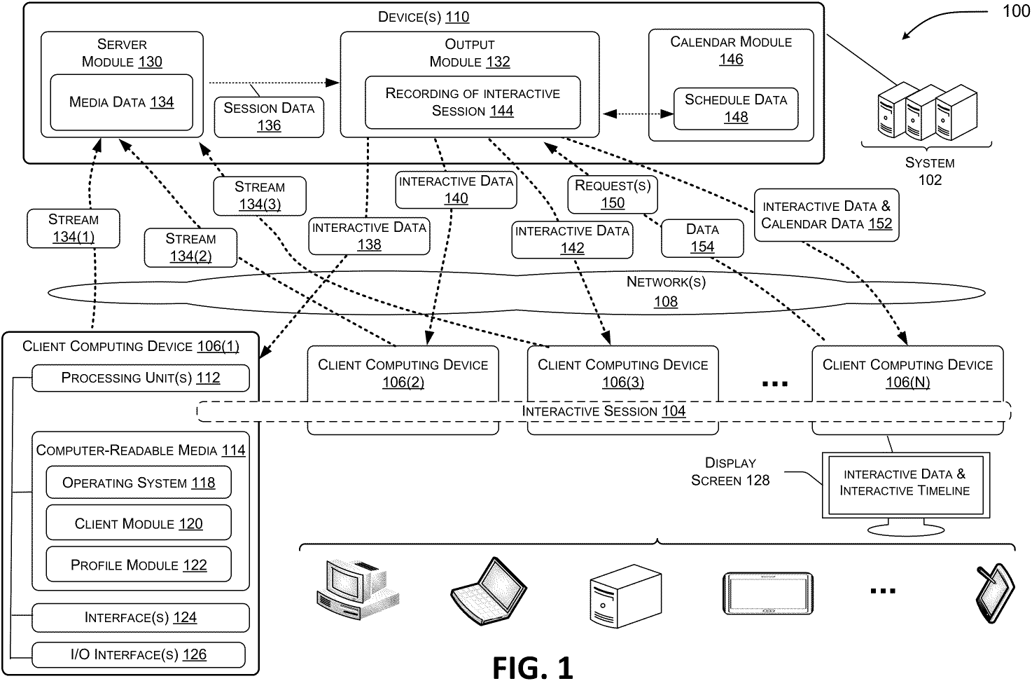

FIG. 1 is a diagram illustrating an example environment 100 in which a system 102 can operate to generate calendar information for an interactive session 104 and to save and edit content. In this example, an interactive session 104 is implemented between a number of client computing devices 106(1) through 106(N) (where N is a positive integer number having a value of two or greater). The client computing devices 106(1) through 106(N) enable users to participate in the interactive session 104. In this example, the interactive session 104 is hosted, over one or more network(s) 108, by the system 102. That is, the system 102 can provide a service that enables users of the client computing devices 106(1) through 106(N) to participate in the interactive session 104 (e.g., via a live viewing and/or a recorded viewing). Consequently, a “participant” to the interactive session 104 can comprise a user and/or a client computing device (e.g., multiple users may be in a conference room participating in a interactive session via the use of a single client computing device), each of which can communicate with other participants. As an alternative, the interactive session 104 can be hosted by one of the client computing devices 106(1) through 106(N) utilizing peer-to-peer technologies.

In examples described herein, client computing devices 106(1) through 106(N) participating in an interactive session 104 are configured to receive and render for display, on a user interface of a display screen, interactive data. The interactive data can comprise a collection of various instances, or streams, of content. For example, an individual stream of content can comprise media data associated with a video feed (e.g., audio and visual data that capture the appearance and speech of a user participating in the interactive session). Another example of an individual stream of content can comprise media data that includes a file displayed on a display screen along with audio data that captures the speech of a user. Accordingly, the various streams of content within the teleconference data enable a remote meeting to be facilitated between a group of people and the sharing of content within the group of people.

The system 102 includes device(s) 110. The device(s) 110 and/or other components of the system 102 can include distributed computing resources that communicate with one another and/or with the client computing devices 106(1) through 106(N) via the one or more network(s) 108. In some examples, the system 102 may be an independent system that is tasked with managing aspects of one or more interactive sessions such as interactive session 104. As an example, the system 102 may be managed by entities such as SLACK, WEBEX, GOTOMEETING, GOOGLE HANGOUTS, etc.

Network(s) 108 may include, for example, public networks such as the Internet, private networks such as an institutional and/or personal intranet, or some combination of private and public networks. Network(s) 108 may also include any type of wired and/or wireless network, including but not limited to local area networks (“LANs”), wide area networks (“WANs”), satellite networks, cable networks, Wi-Fi networks, WiMax networks, mobile communications networks (e.g., 3G, 4G, and so forth) or any combination thereof. Network(s) 108 may utilize communications protocols, including packet-based and/or datagram-based protocols such as Internet protocol (“IP”), transmission control protocol (“TCP”), user datagram protocol (“UDP”), or other types of protocols. Moreover, network(s) 108 may also include a number of devices that facilitate network communications and/or form a hardware basis for the networks, such as switches, routers, gateways, access points, firewalls, base stations, repeaters, backbone devices, and the like.

In some examples, network(s) 108 may further include devices that enable connection to a wireless network, such as a wireless access point (“WAP”). Examples support connectivity through WAPs that send and receive data over various electromagnetic frequencies (e.g., radio frequencies), including WAPs that support Institute of Electrical and Electronics Engineers (“IEEE”) 802.11 standards (e.g., 802.11 g, 802.11n, and so forth), and other standards.

In various examples, device(s) 110 may include one or more computing devices that operate in a cluster or other grouped configuration to share resources, balance load, increase performance, provide fail-over support or redundancy, or for other purposes. For instance, device(s) 110 may belong to a variety of classes of devices such as traditional server-type devices, desktop computer-type devices, and/or mobile-type devices. Thus, although illustrated as a single type of device—a server-type device—device(s) 110 may include a diverse variety of device types and are not limited to a particular type of device. Device(s) 110 may represent, but are not limited to, server computers, desktop computers, web-server computers, personal computers, mobile computers, laptop computers, tablet computers, or any other sort of computing device.

A client computing device (e.g., one of client computing device(s) 106(1) through 106(N)) (each of which are also referred to herein as a “data processing system”) may belong to a variety of classes of devices, which may be the same as, or different from, device(s) 110, such as traditional client-type devices, desktop computer-type devices, mobile-type devices, special purpose-type devices, embedded-type devices, and/or wearable-type devices. Thus, a client computing device can include, but is not limited to, a desktop computer, a game console and/or a gaming device, a tablet computer, a personal data assistant (“PDA”), a mobile phone/tablet hybrid, a laptop computer, a telecommunication device, a computer navigation type client computing device such as a satellite-based navigation system including a global positioning system (“GPS”) device, a wearable device, a virtual reality (“VR”) device, an augmented reality (AR) device, an implanted computing device, an automotive computer, a network-enabled television, a thin client, a terminal, an Internet of Things (“IoT”) device, a work station, a media player, a personal video recorders (“PVR”), a set-top box, a camera, an integrated component (e.g., a peripheral device) for inclusion in a computing device, an appliance, or any other sort of computing device. Moreover, the client computing device may include a combination of the earlier listed examples of the client computing device such as, for example, desktop computer-type devices or a mobile-type device in combination with a wearable device, etc.

Client computing device(s) 106(1) through 106(N) of the various classes and device types can represent any type of computing device having one or more processing unit(s) 112 operably connected to computer-readable media 114 such as via a bus 116, which in some instances can include one or more of a system bus, a data bus, an address bus, a PCI bus, a Mini-PCI bus, and any variety of local, peripheral, and/or independent buses.

Executable instructions stored on computer-readable media 114 may include, for example, an operating system 118, a client module 120, a profile module 122, and other modules, programs, or applications that are loadable and executable by processing units(s) 112.

Client computing device(s) 106(1) through 106(N) may also include one or more interface(s) 124 to enable communications between client computing device(s) 106(1) through 106(N) and other networked devices, such as device(s) 110, over network(s) 108. Such network interface(s) 124 may include one or more network interface controllers (NICs) or other types of transceiver devices to send and receive communications and/or data over a network. Moreover, a client computing device 106(1) can include input/output (“I/O”) interfaces 126 that enable communications with input/output devices such as user input devices including peripheral input devices (e.g., a game controller, a keyboard, a mouse, a pen, a voice input device such as a microphone, a touch input device, a gestural input device, and the like) and/or output devices including peripheral output devices (e.g., a display, a printer, audio speakers, a haptic output device, and the like). FIG. 10 illustrates that client computing device 106(N) is in some way connected to a display device (e.g., a display screen 128), which can display the interactive timeline for the interactive session 104, as shown.

In the example environment 100 of FIG. 1, client computing devices 106(1) through 106(N) may use their respective client modules 120 to connect with one another and/or other external device(s) in order to participate in the interactive session 104. For instance, a first user may utilize a client computing device 106(1) to communicate with a second user of another client computing device 106(2). When executing client modules 120, the users may share data, which may cause the client computing device 106(1) to connect to the system 102 and/or the other client computing devices 106(2) through 106(N) over the network(s) 108.

The client computing device(s) 106(1) through 106(N) may use their respective profile module 122 to generate participant profiles and provide the participant profiles to other client computing devices and/or to the device(s) 110 of the system 102. A participant profile may include one or more of an identity of a user or a group of users (e.g., a name, a unique identifier (“ID”), etc.), user data such as personal data, machine data such as location (e.g., an IP address, a room in a building, etc.) and technical capabilities, etc. Participant profiles may be utilized to register participants for interactive sessions.

As shown in FIG. 1, the device(s) 110 of the system 102 includes a server module 130 and an output module 132. The server module 130 is configured to receive, from individual client computing devices such as client computing devices 106(1) through 106(3), media streams 134(1) through 134(3). As described above, media streams can comprise a video feed (e.g., audio and visual data associated with a user), audio data which is to be output (e.g., an audio only experience in which video data of the user is not transmitted), text data (e.g., text messages), file data and/or screen sharing data (e.g., a document, a slide deck, an image, a video displayed on a display screen, etc.), and so forth. Thus, the server module 130 is configured to receive a collection of various media streams 134(1) through 134(3) (the collection being referred to herein as media data 134). In some scenarios, not all the client computing devices that participate in the interactive session 104 provide a media stream. For example, a client computing device may only be a consuming, or a “listening”, device such that it only receives content associated with the interactive session 104 but does not provide any content to the interactive session 104.

The server module 130 is configured to generate session data 136 based on the media data 134. In various examples, the server module 130 can select aspects of the media data 134 that are to be shared with the participating client computing devices 106(1) through 106(N). Consequently, the server module 130 is configured to pass the session data 136 to the output module 132 and the output module 132 may communicate teleconference data to the client computing devices 106(1) through 106(3). As shown, the output module 132 transmits teleconference data 138 to client computing device 106(1), transmits teleconference data 140 to client computing device 106(2), and transmits interactive data 142 to client computing device 106(3). The interactive data transmitted to the client computing devices can be the same or can be different (e.g., positioning of streams of content within a user interface may vary from one device to the next). The output module 132 is also configured to record the interactive session (e.g., a version of the interactive data) and to maintain a recording of the interactive session 144.

The device(s) 110 can also include a calendar module 146, and in various examples, the calendar module 146 is configured to manage schedule data 148 in the session data 136 and/or events relevant to interactive session 144.

A client computing device such as client computing device 106(N) can provide a request 150 to view a recording of the interactive session 104. In response, the output module 132 can provide interactive data and calendar data 152 to be displayed on a display screen 128 associated with the client computing device 106(N). The teleconference data transmitted to client computing device 106(N) comprises previously recorded content of the interactive session 104. As further described herein, a user of client computing device 106(N) can provide input(s) to add supplemental recorded content to the interactive session 104 and/or to the interactive timeline, and data 154 associated with the supplemental recorded content can be transmitted from client computing device 106(N) to the system 102 so that the recording of the interactive session 144 and the interactive timeline can be updated with the supplemental recorded content. This enables other participants (e.g., users of client computing devices 106(1) through 106(3)) to consume or view the supplemental recorded content after the live viewing of the interactive session has already ended. An improved human-computer interface (“HCI”) is disclosed herein for interacting with representations of calendar and calendar content. In some embodiments, the calendar information may be presented in conjunction with a communications platform such as a videoconferencing platform. Such a system may be referred to as an interactive calendaring and scheduling system.

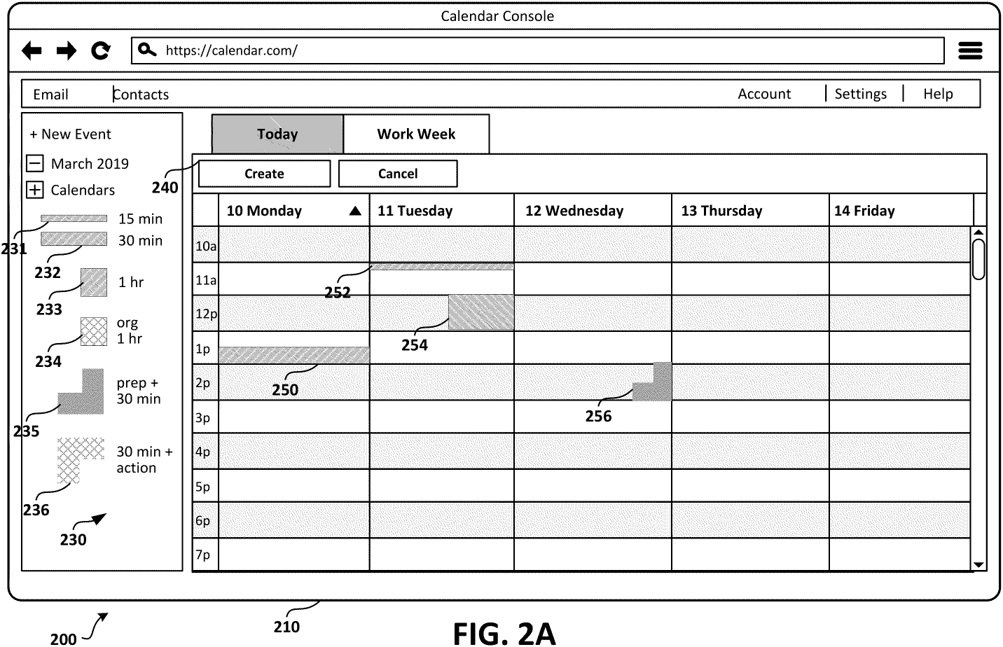

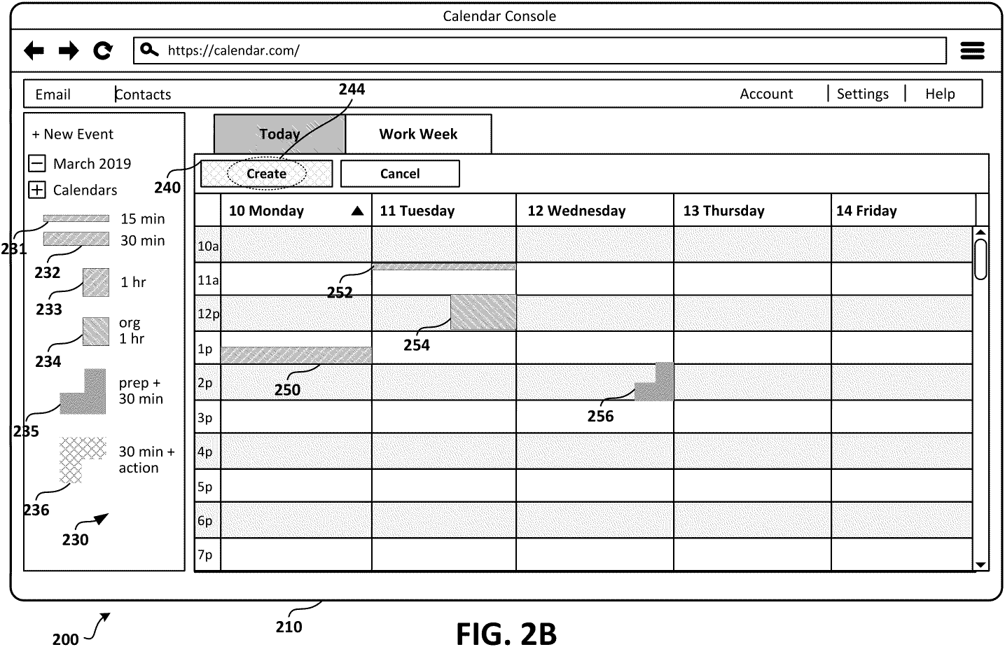

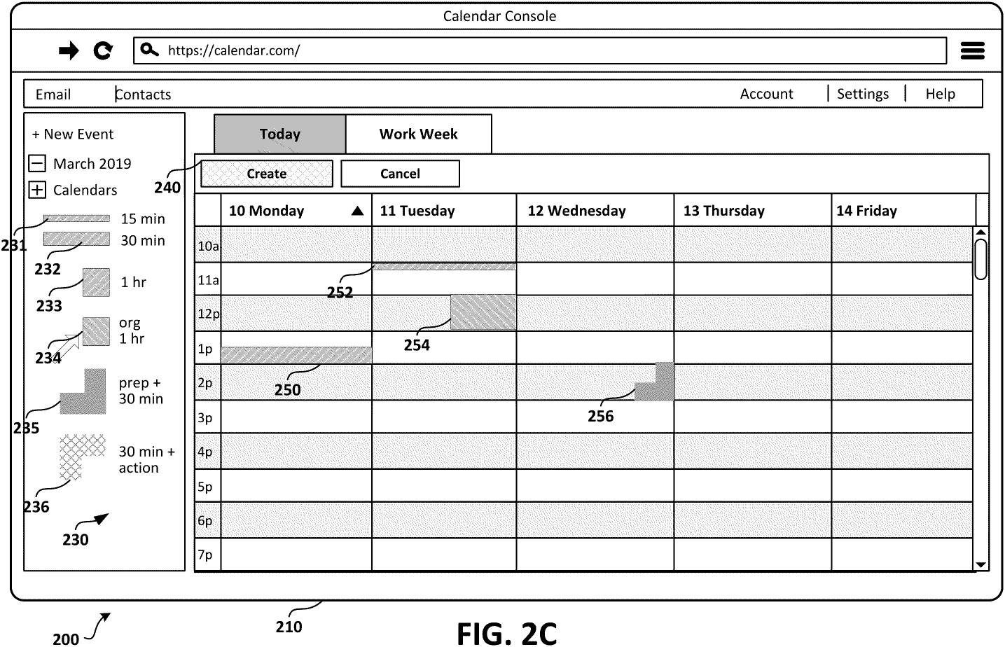

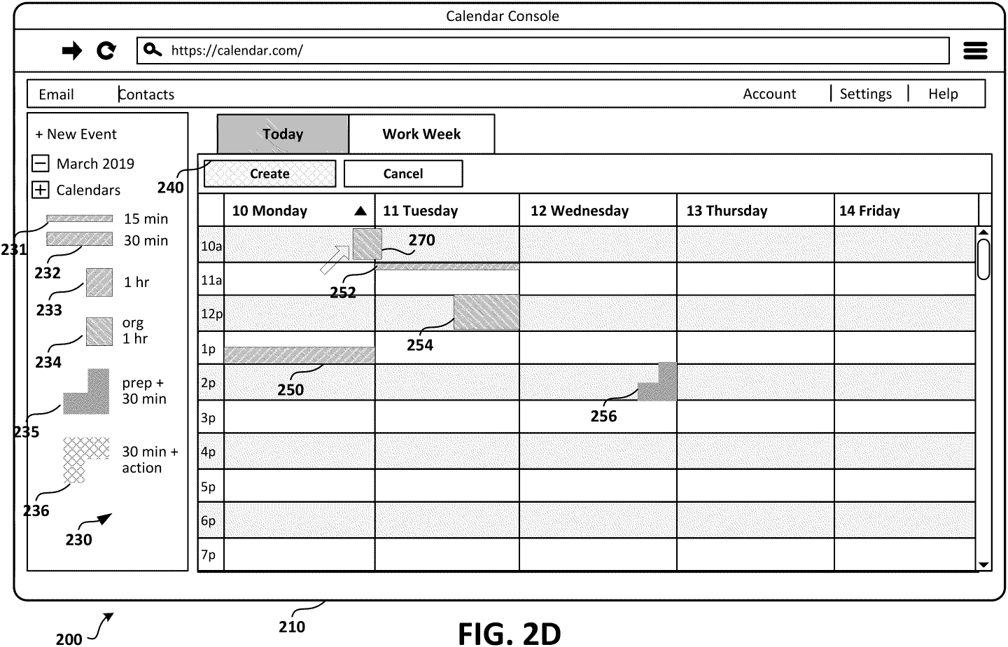

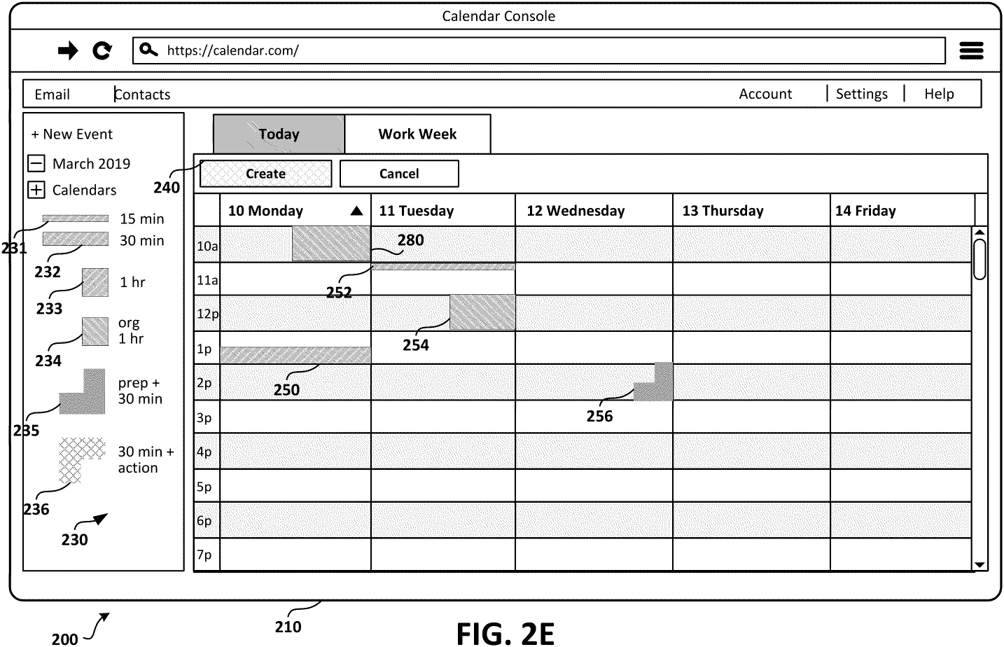

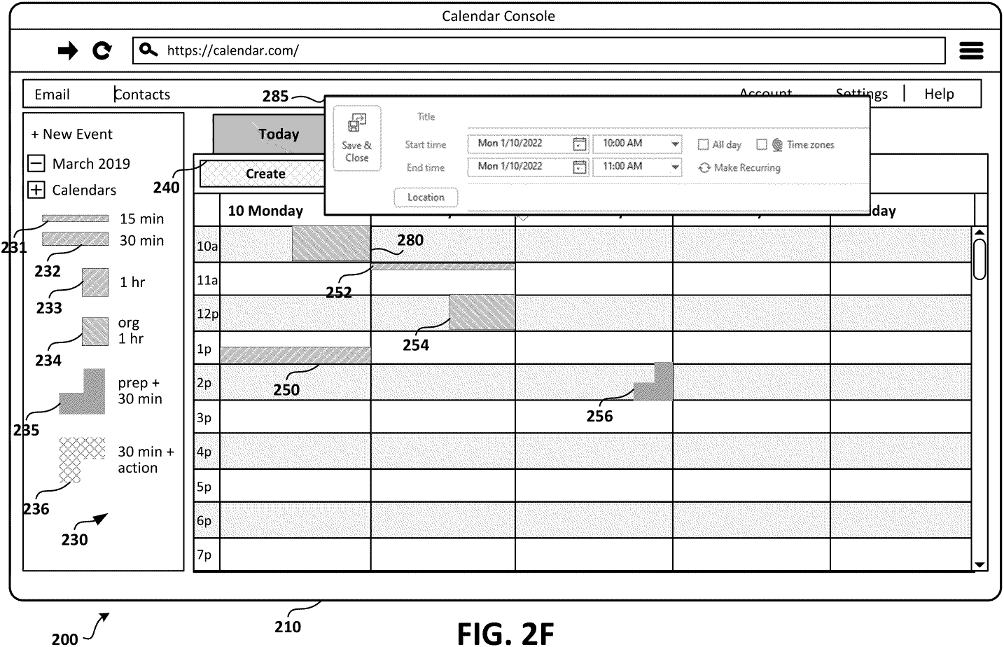

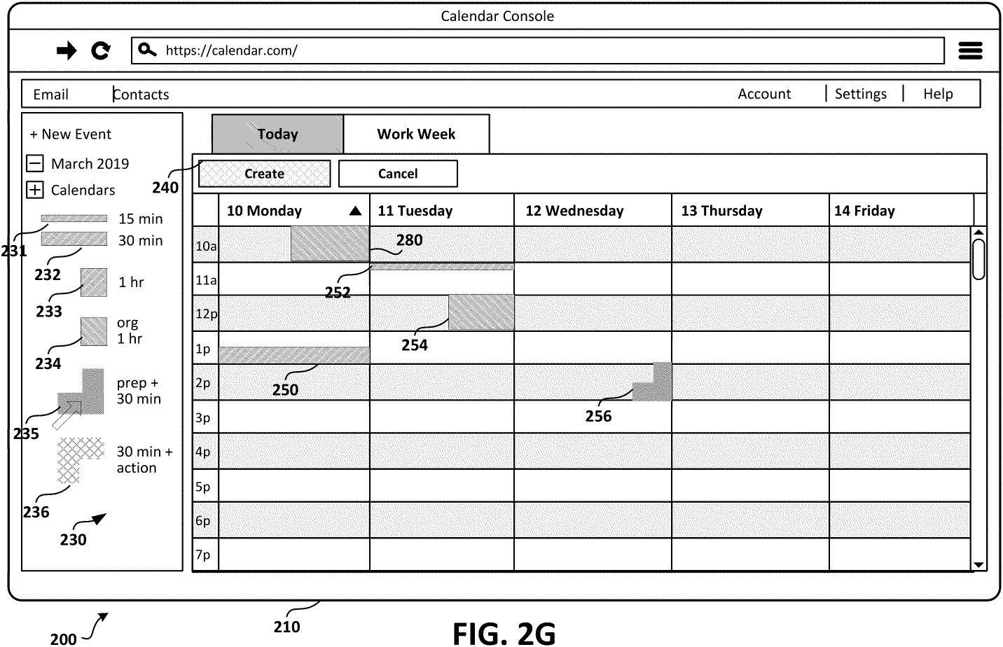

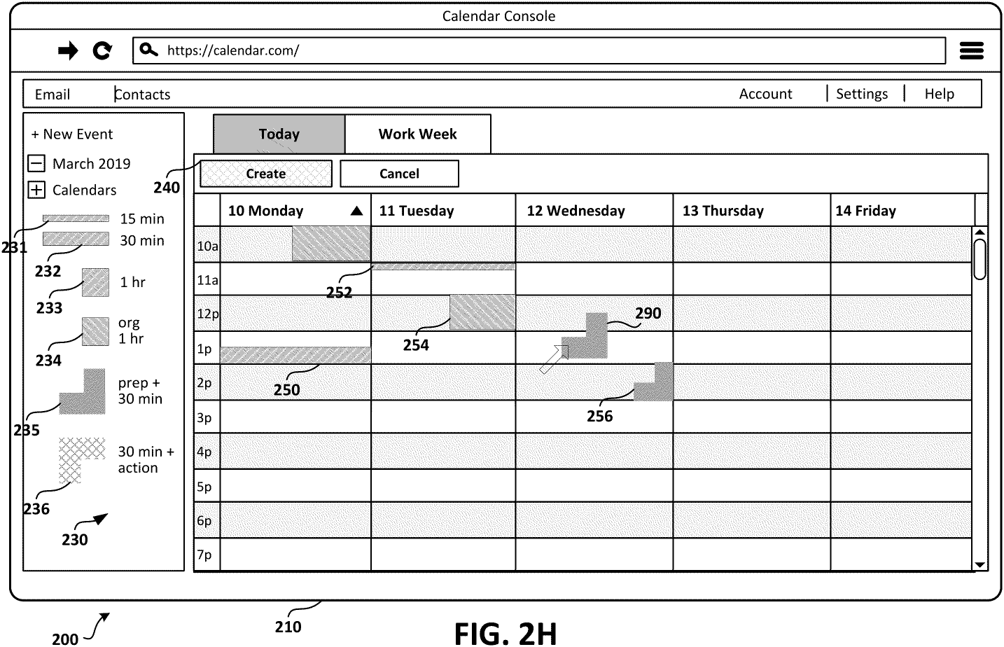

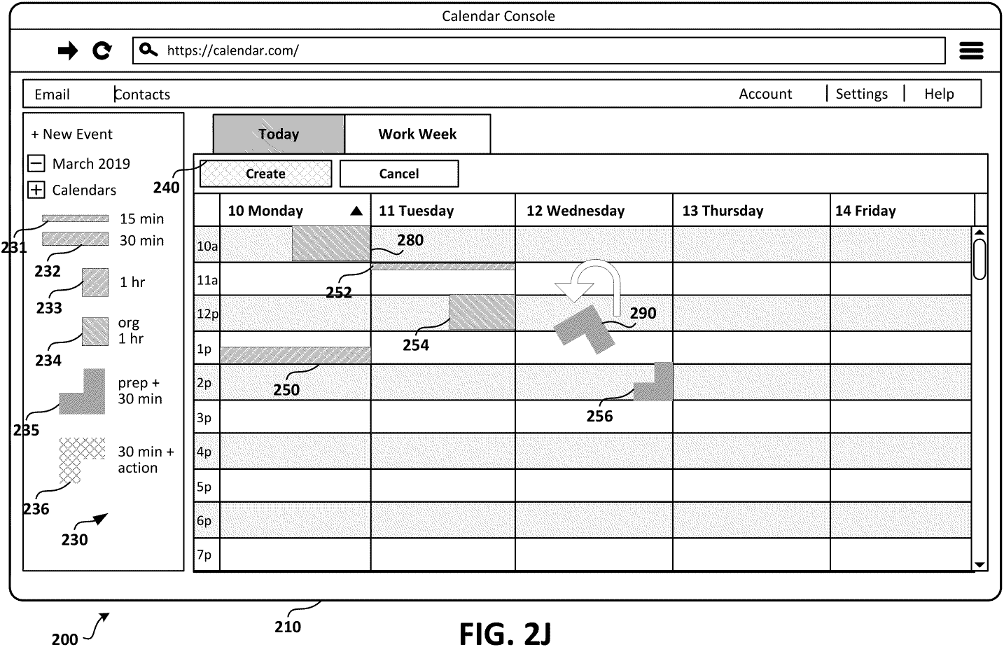

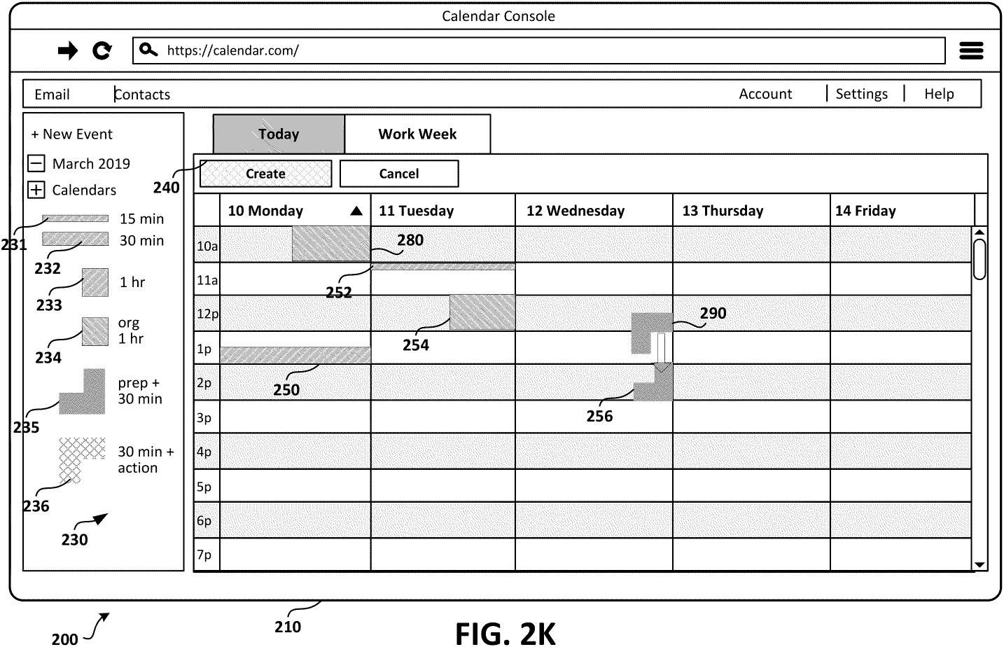

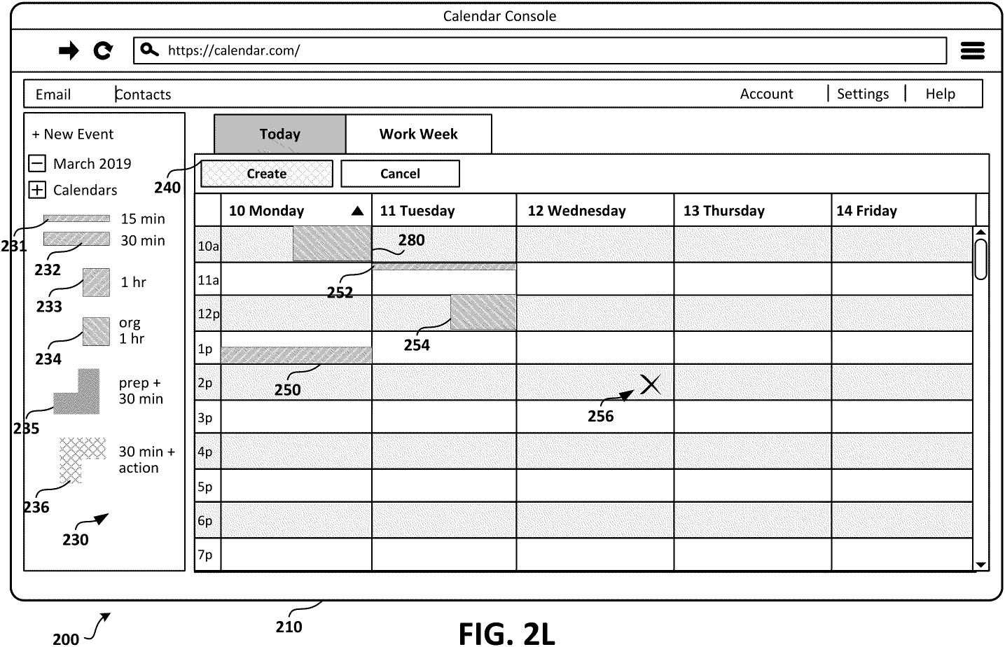

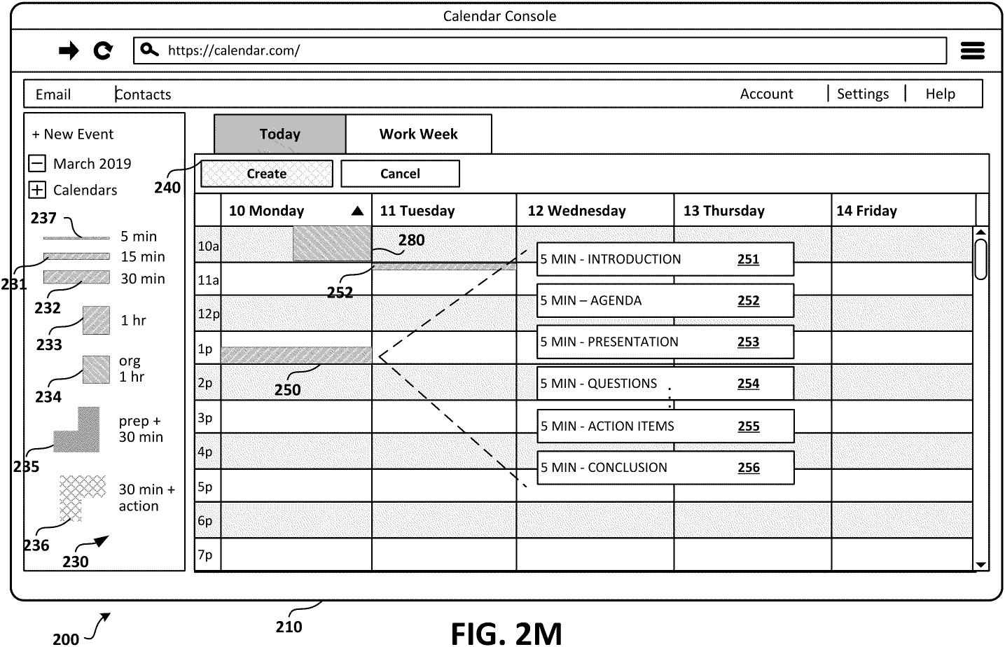

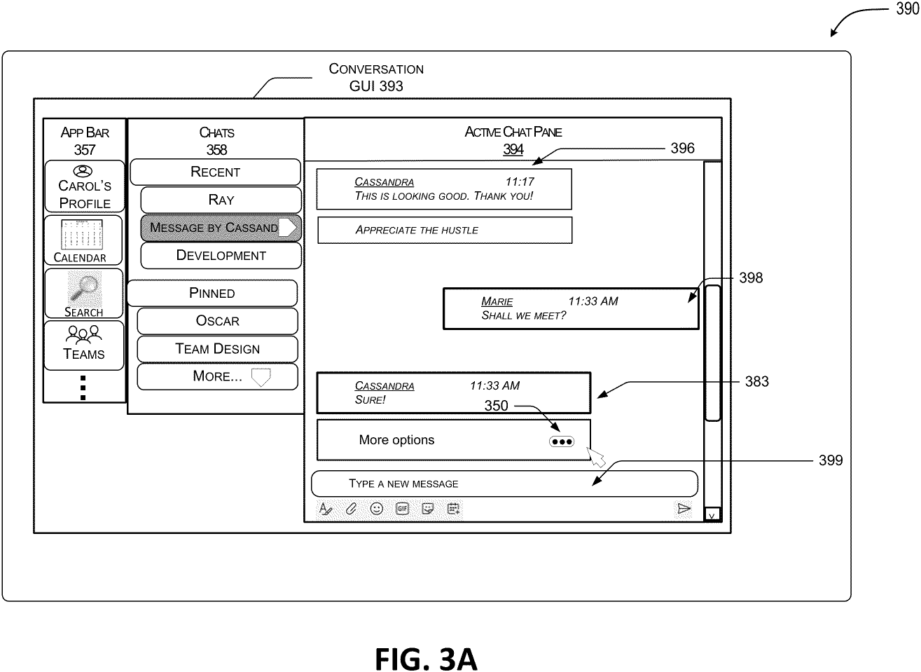

FIG. 2A illustrates an example of a user interface 200 where a calendaring application 210 is rendered before a dynamic calendar event update. The calendaring application 210 illustrated in FIG. 2A may represent a variety of applications, including but not limited to Microsoft® Teams, Skype for Business®, and Microsoft Office® products. The calendaring application 210 may display a representation of a calendar view on the user interface 200. The calendar view may include one or more calendar days, the calendar days comprising a time span including a plurality of time slots. Scheduled meetings 250, 252, 254, and 256 may be rendered in at least some of the time slots. Also illustrated are selectable and graphically movable template meeting objects 230. In this example, the meeting objects 230 may include a 15 minute meeting 231, 30 minute meeting 232, and 1 hour meeting 233. These meetings may be of a first type, such as a personal or small meeting, as indicated by the first hash pattern. Also illustrated is a second type of 1 hour meeting 234, as indicated by the second hash pattern, which may indicate a large or organization meeting. The meeting objects 230 may include meetings with add-ons, such as a prep + 30 minute meeting 235, or a 30 minute meeting + action 236. The prep + 30 minute meeting 235 may be a 30 minute meeting that includes a 30 minute reserve for meeting preparation prior to the start of the 30 minute meeting. The 30 minute meeting + action meeting 236 may be a 30 minute meeting that includes a 30 minute reserve for meeting action follow-up after the end of the 30 minute meeting. As shown in FIG. 2A, meeting 252 may be a 15 minute meeting, meeting 254 may be a 1 hour meeting, meeting 250 may be a 30 minute meeting, and meeting 256 may be a prep + 30 minute meeting.

Referring to FIG. 2B, the calendar 210 may be dynamically updated based on use of the meeting objects 230. In one example, the meeting objects 230 may be rendered in response to a selection 244 of a create button 240. In other examples, the meeting objects 230 may be rendered on the calendar 210 by default or based on a user or system setting.

Referring to FIG. 2C, illustrated is selection of the 1 hour organization meeting 234. Selection of the 1 hour organization meeting 234 may be effected by using an input such as selection using a mouse, touchscreen, or other methods. FIG. 2D illustrates movement, via a user input, of the object 270 representing the 1 hour organization meeting 234 onto the calendar proximate to the Monday 10 am time slot. As shown in FIG. 2E, if the object 270 is placed and released proximate to the Monday 10 am time slot, a meeting 280 is created that corresponds to a 1 hour organization meeting that begins on Monday at 10 am.

FIG. 2F further illustrates that in response to the meeting 280 being created, a window 285 may be rendered for confirming and entering any additional details for the meeting 280. Some of the meeting details may be prepopulated based on the meeting object that was selected and where the meeting object was placed on the calendar 210.

In addition to creating meetings, the template meeting objects 230 may also be used to modify or delete meetings. For example, FIG. 2G illustrates selection of the prep + 30 minute meeting template 235, which corresponds to meeting 256. FIG. 2H illustrates moving the selected prep + 30 minute meeting object 290 near the meeting 256. FIG. J illustrates rotation of the selected prep + 30 minute meeting object 290. Rotation may be effected using arrow keys on the user keyboard, selecting and rotating a handle that may be rendered when the selected prep + 30 minute meeting object 290 is selected, or other means of rotating a graphics object. FIG. 2K illustrates that the selected prep + 30 minute meeting object 290 was rotated 180 degrees so as to be a mirror image of the shape of meeting 256. Similar to the operation of the well known game Tetris, the rotated meeting object 290 may be matched and “snapped” to the meeting 256, which in FIG. 2L has been deleted in response to the matching action.

In addition to the above examples, other user actions can be used to make other kinds of calendar modifications. The use of such graphics-oriented actions to modify or create calendar entries provides an intuitive and efficient method of providing user inputs.

In some embodiments, the size, shape, and/or types of meeting objects can be predetermined based on various factors. In one example, the size, shape, and/or types of meeting objects available for a given user may be predetermined by an administrator of an enterprise, business unit, organization, and the like. The predetermined may be based on a role of the user, a security level of the user, or other properties of the user. In this way, the meeting objects may be tailored to the specific needs of a particular type of user or the user’s membership. This may allow for the user to be presented with the meeting objects that are most likely to be used.

In some embodiments, the meeting objects that are displayed may be selectable by the user. For example, the user may opt to display only those meeting objects that the user commonly uses. In other embodiments, the meeting objects that are displayed may be automatically selected based on the user’s usage history, predictive analysis, or other methodologies.

As noted, the types of meeting objects illustrated herein are illustrative examples, and are not intended to limit the duration or type of meeting objects that are contemplated by the present disclosure. For example, meeting durations can be longer than those illustrated herein, or can be shorter than those that are illustrated. As noted above, the meeting objects that are displayed may be selectable by the user. In some embodiments, the user may be provided an option to create a meeting object with a user specified meeting duration and meeting type. In one embodiment, a meeting object can be broken down into more granular objects with a shorter meeting duration. This can provide the user with the ability to build a more detailed calendar of meetings and activities in as much detail as desired. For example, FIG. 2M illustrates that the 30 minute meeting 250 may be further broken into a number of 5 minute meeting objects 237. In the example, meeting 250 may include 5 minute segments introduction 251, agenda 252, presentation 253, questions 254, action items 255, and conclusion 256.

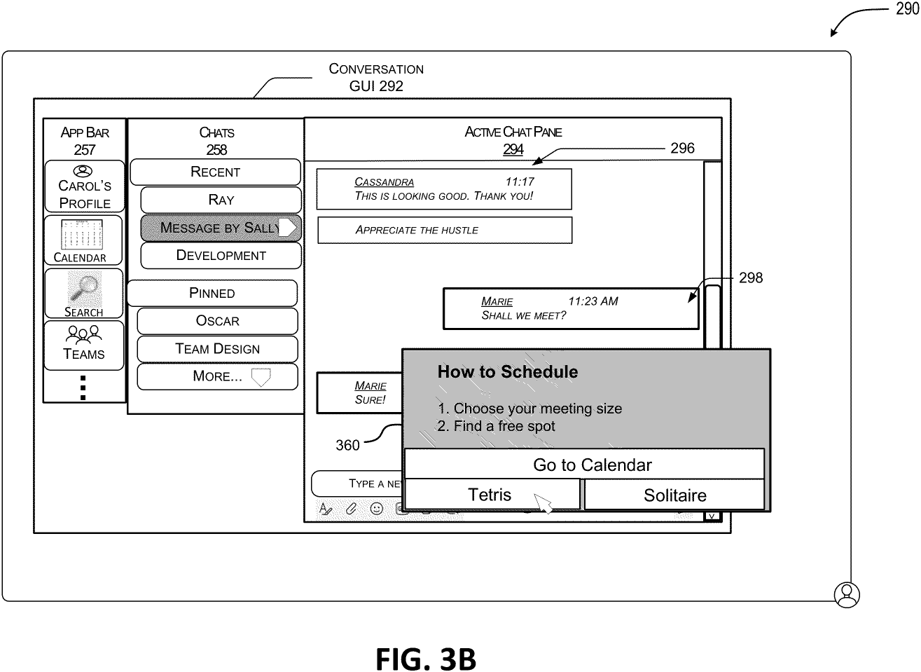

In some embodiments, the option to utilize the meeting objects illustrated in FIGS. 2A through 2L may be initiated from other interactive and collaborative activities based on a context that indicates that a new meeting may be desired. FIG. 3A is an example of a display screen 390 presenting a graphical user interface (GUI) 393 that illustrates shared messages in a chat session. As illustrated, the graphical user interface 393 may be associated with a messaging application such that it contains conversations, and therefore, may be referred to herein as a conversation GUI 393. In the example of FIG. 3A, the conversation GUI 393 includes an app bar 357, a list of conversations/channels 358, and an active conversation pane 394.

The user may enter responses which may be shown on the active pane 394, for example by entering messages in response bar 393. When the context of a chat session indicates that a meeting is desired, such as the question posed in message 398 and the response provided in message 383, an option pane 350 may be rendered to enable the user to launch further options pertaining to the desired meeting.

Referring to FIG. 3B, an interactive pane 360 is provided that enables a user to go to the calendar application. The interactive pane 360 may also provide options for specific types of interactive calendaring interfaces.

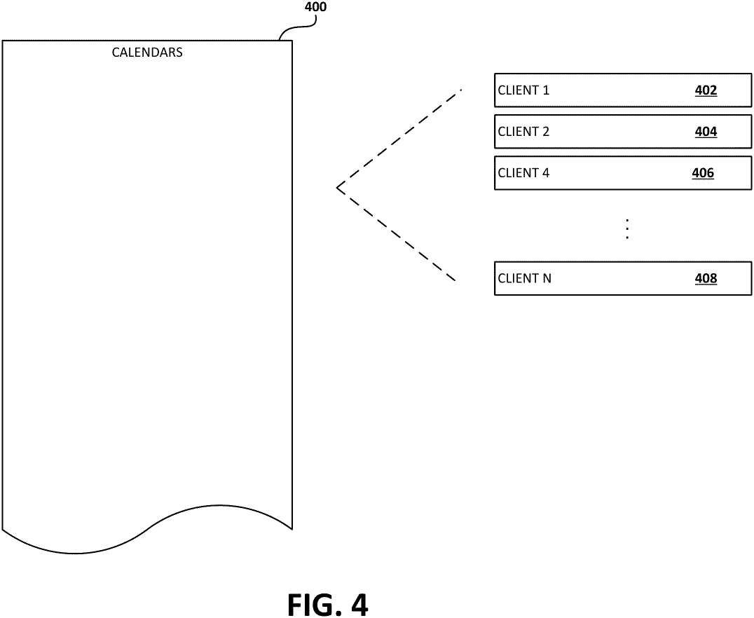

Turning to FIG. 4, illustrated is an example application 400 rendering or otherwise processing calendar sessions for a number of clients 402, 404, 406, and 408, which in various scenarios can be users or participants in a scheduling platform.

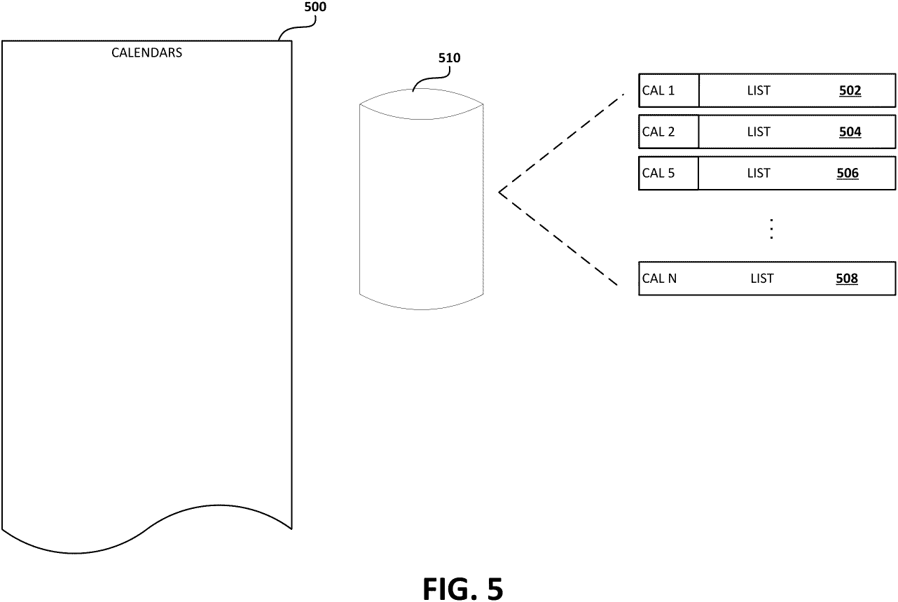

Turning to FIG. 5, illustrated is an example data storage 510 which may store thereon a database storing calendar data for the clients 502, 504, 506, and 508. For each calendar, the record for each calendar may include a list of meetings in each calendar. As used herein, the record for each calendar as well as other records described herein may be implemented as a data structure. It will be appreciated by one skilled in the art that the data structure shown in the figure may represent a data file, a database table, an object stored in a computer storage, a programmatic structure or any other data container commonly known in the art. Each data element included in the data structure may represent one or more fields in a data file, one or more columns of a database table, one or more attributes of an object, one or more variables of a programmatic structure or any other unit of data of a data structure commonly known in the art.

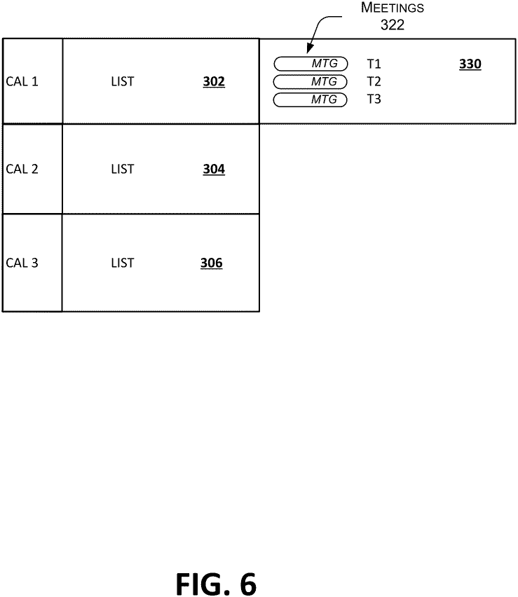

Turning to FIG. 6, illustrated is data structure 630 which may store thereon a record of meetings 622 for each calendar and associated data (e.g., start times, duration) for the meetings. In some embodiments, metadata can be included for each calendar such as meeting type, attendees, and the like.

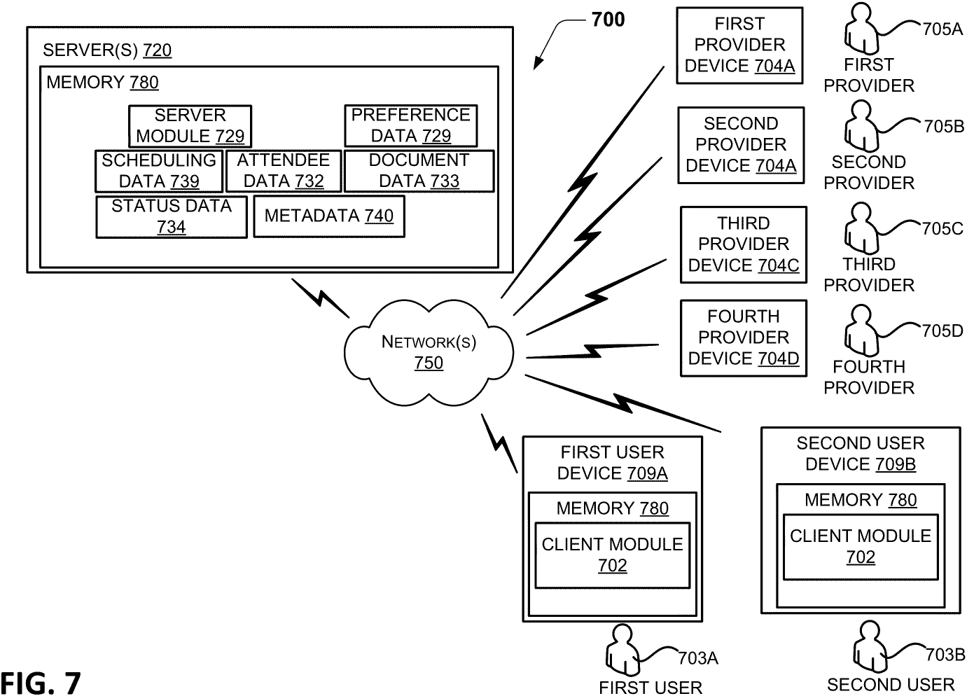

FIG. 7 is a block diagram showing aspects of one example environment 700, also referred to herein as a “system 700,” disclosed herein for providing dynamic updating of calendar events. In one illustrative example, the example environment 700 can include one or more servers 720, one or more networks 750, one or more user devices 709A-709B (collectively “user devices 709”), one or more provider devices 704A-704D (collectively “provider devices 704”), and one or more resources 706A-706E (collectively “resources 706”). The user devices 709 can be utilized for interaction with one or more users 703A-703B (collectively “users 703”), and the provider devices 704 can be utilized for interaction with one or more service providers 705A-705D (collectively “service providers 705”). This example is provided for illustrative purposes and is not to be construed as limiting. It can be appreciated that the example environment 700 can include any number of devices, users, providers, and/or any number of servers 720.

For illustrative purposes, the service providers 705 can be a company, person, or any type of entity capable of providing services or products for the users 703, which can also be a company, person or other entity. For illustrative purposes, the service providers 705 and the users 703 can be generically and individually referred to herein as “users.” In some configurations, a data object may include one or more calendar events. Contextual data can be analyzed to determine one or more calendar events that can be updated dynamically.

The user devices 709, provider devices 704, servers 720 and/or any other computer configured with the features disclosed herein can be interconnected through one or more local and/or wide area networks, such as the network 750. In addition, the computing devices can communicate using any technology, such as BLUETOOTH, WIFI, WIFI DIRECT, NFC or any other suitable technology, which may include light-based, wired, or wireless technologies. It should be appreciated that many more types of connections may be utilized than described herein.

A user device 709 or a provider device 704 (collectively “computing devices”) can operate as a stand-alone device, or such devices can operate in conjunction with other computers, such as the one or more servers 720. Individual computing devices can be in the form of a personal computer, mobile phone, tablet, wearable computer, including a head-mounted display (HMD) or watch, or any other computing device having components for interacting with one or more users and/or remote computers. In one illustrative example, the user device 709 and the provider device 704 can include a local memory 680, also referred to herein as a “computer-readable storage medium” or “non-transitory computer-readable storage medium” configured to store data, such as a client module 702 and other contextual data described herein.

The servers 720 may be in the form of a personal computer, server farm, large-scale system or any other computing system having components for processing, coordinating, collecting, storing, and/or communicating data between one or more computing device. In one illustrative example, the servers 720 can include a local memory 680, also referred to herein as a “computer-readable storage medium,” configured to store data, such as a server module 729 and other data described herein. The servers 720 can also include components and services, such as the application services and shown in FIG. 7, for providing, receiving, and processing calendar data and executing one or more aspects of the techniques described herein. As will be described in more detail herein, any suitable module may operate in conjunction with other modules or devices to implement aspects of the techniques disclosed herein.

In some configurations, an application programming interface (API) exposes an interface through which an operating system and application programs executing on the computing device can enable the functionality disclosed herein. Through the use of this data interface and other interfaces, the operating system and application programs can communicate and process contextual data and modify scheduling data as described herein.

The scheduling data 739 can define appointments for the users 703 and the providers 705. The scheduling data 739 can define a start time and an end time. The scheduling data 739 can also include location data if an appointment is associated with a geographic location, global coordinates, and other information identifying a location. The scheduling data 739 can define a single appointment or a series of appointments. In addition, the scheduling data 739 can include communication information such as a phone number, IM address, URL, or other information for facilitating a voice or video conference. The scheduling data 739 can also include a text description of an appointment and other data indicating a topic, service category, a user 703 and/or a provider 705. The scheduling data 739 can be stored on the server 720, user device 709, provider device 704, or any suitable computing device, which may include a Web-based service.

The attendee data 732 may include a listing of a number of attendees that are scheduled for a meeting. The attendee data 732 can also be based on scheduling data 739. The document data 733 may include documents that are shared during a meeting. The status data 734 can define the availability of one or more parties. For instance, status data 734 can indicate if a party is unavailable, available, or unavailable until a particular date. The status data 734 can also define a level of availability. These examples are provided for illustrative purposes and are not to be construed as limiting. It can be appreciated that the status data 734 include a form of data indicating the availability of a company, an individual or a group of individuals. The preference data 729 can include user-defined preferences or provider-defined preferences.

To enable aspects of the techniques disclosed herein, one or more computing devices of FIG. 7 can be configured to generate data defining one or more live updates in response to detecting the presence of a condition. In some configurations, implementations can include receiving scheduling data defining a calendar event. In addition, the implementations can include obtaining contextual data from a plurality of resources. As described in more detail herein, the contextual data can include additional scheduling data, live meeting date, meeting participants, and/or other data that relating to a calendar event.

One or more computing devices can be configured to identify a pattern of the contextual data indicating a presence of a condition that affects one or more aspects of a calendar event. A condition can include the introduction or modification of a calendar event, and/or other events or data that can impact aspects of a calendar event.

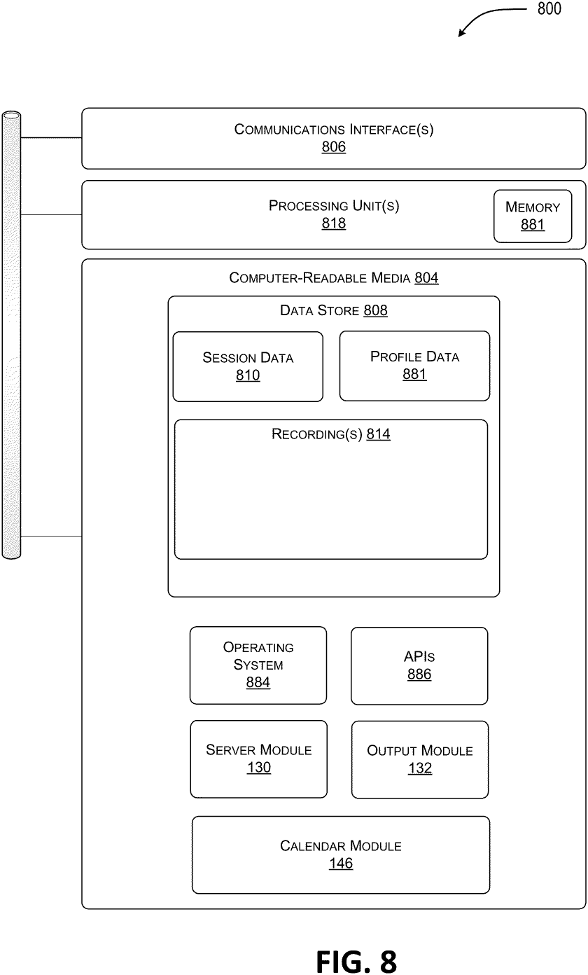

FIG. 8 illustrates a diagram that shows example components of an example device 800 configured to render and update calendar data. The device 800 may represent one of device(s) 106, or in other examples a client computing device (e.g., client computing device 106(1)), where the device 800 includes one or more processing unit(s) 808, computer-readable media 804, and communication interface(s) 806. The components of the device 800 are operatively connected, for example, via a bus, which may include one or more of a system bus, a data bus, an address bus, a PCI bus, a Mini-PCI bus, and any variety of local, peripheral, and/or independent buses.

As utilized herein, processing unit(s), such as the processing unit(s) 808 and/or processing unit(s) 88, may represent, for example, a CPU-type processing unit, a GPU-type processing unit, a field-programmable gate array (“FPGA”), another class of digital signal processor (“DSP”), or other hardware logic components that may, in some instances, be driven by a CPU. For example, and without limitation, illustrative types of hardware logic components that may be utilized include Application-Specific Integrated Circuits (“ASICs”), Application-Specific Standard Products (“ASSPs”), System-on-a-Chip Systems (“SOCs”), Complex Programmable Logic Devices (“CPLDs”), etc.

As utilized herein, computer-readable media, such as computer-readable media 804, may store instructions executable by the processing unit(s). The computer-readable media may also store instructions executable by external processing units such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in a computing device, while in some examples one or more of a CPU, GPU, and/or accelerator is external to a computing device.

Computer-readable media may include computer storage media and/or communication media. Computer storage media may include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random-access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), flash memory, compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer storage media, communication media may embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

Communication interface(s) 806 may represent, for example, network interface controllers (“NICs”) or other types of transceiver devices to send and receive communications over a network.

In the illustrated example, computer-readable media 804 includes a data store 808. In some examples, data store 808 includes data storage such as a database, data warehouse, or other type of structured or unstructured data storage. In some examples, data store 808 includes a corpus and/or a relational database with one or more tables, indices, stored procedures, and so forth to enable data access including one or more of hypertext markup language (“HTML”) tables, resource description framework (“RDF”) tables, web ontology language (“OWL”) tables, and/or extensible markup language (“XML”) tables, for example.

The data store 808 may store data for the operations of processes, applications, components, and/or modules stored in computer-readable media 804 and/or executed by processing unit(s) 818 and/or accelerator(s). For instance, in some examples, data store 808 may store session data 810 (e.g., session data 136), profile data 881 (e.g., associated with a participant profile), and/or other data. The session data 810 can include a total number of participants (e.g., users and/or client computing devices) in the interactive session 104, and activity that occurs in the interactive session 104, and/or other data related to when and how the interactive session 104 is conducted or hosted. The data store 808 can also include recording(s) 814 of interactive session(s).

Alternately, some or all of the above-referenced data can be stored on separate memories 881 on board one or more processing unit(s) 818 such as a memory on board a CPU-type processor, a GPU-type processor, an FPGA-type accelerator, a DSP-type accelerator, and/or another accelerator. In this example, the computer-readable media 804 also includes operating system 884 and application programming interface(s) 886 configured to expose the functionality and the data of the device 800 to other devices. Additionally, the computer-readable media 804 includes one or more modules such as the server module 130, the output module 132, and the calendar module 146, although the number of illustrated modules is just an example, and the number may vary higher or lower. That is, functionality described herein in association with the illustrated modules may be performed by a fewer number of modules or a larger number of modules on one device or spread across multiple devices.

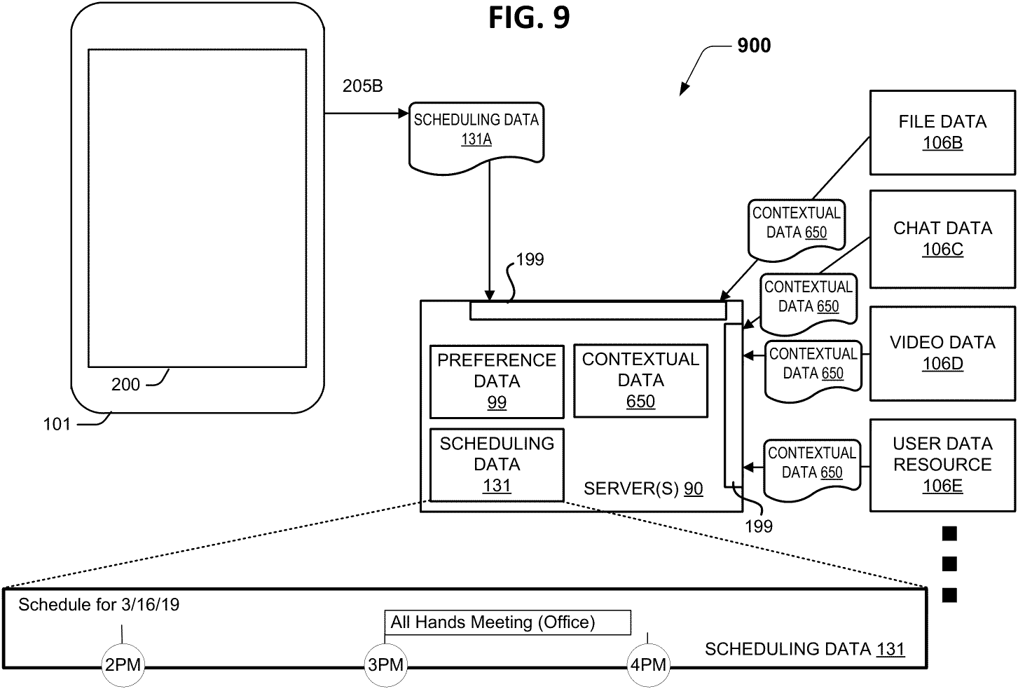

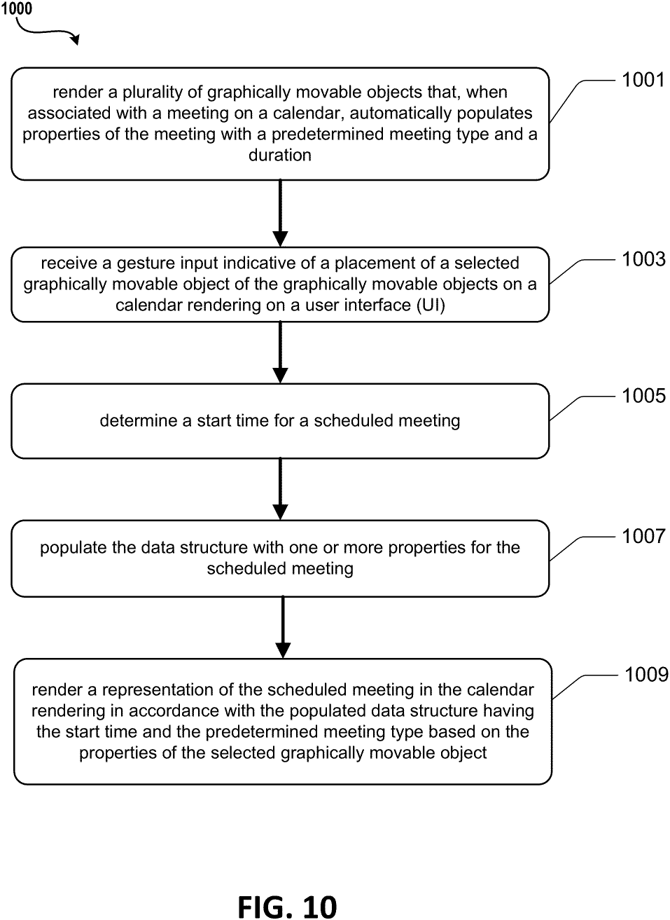

FIG. 9 illustrates aspects of the system 900 that provide a framework for several example scenarios utilizing the techniques disclosed herein. More specifically, this block diagram of the system 900 shows an illustrative example of the server 90 receiving scheduling data 131 defining a scheduled meeting. The server 90 is also storing scheduling data 131 defining a number of calendar events for a user and preference data 99. The server 90 also receives contextual data 650 from a number of resources 106A-106E, as well as other resources described herein. To illustrate aspects of the examples described below, the user device 101 is displaying a user interface (UI) 200 showing a calendar object.

FIG. 10 is a diagram illustrating aspects of a routine 1000 according to one embodiment disclosed herein. It should be understood by those of ordinary skill in the art that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, performed together, and/or performed simultaneously, without departing from the scope of the appended claims.

It should also be understood that the illustrated methods can end at any time and need not be performed in their entireties. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system such as those described herein) and/or (2) as interconnected machine logic circuits or circuit modules within the computing system. The implementation is a matter of choice dependent on the performance and other requirements of the computing system. Accordingly, the logical operations may be implemented in software, in firmware, in special purpose digital logic, and any combination thereof.

Additionally, the operations illustrated in FIG. 10 and the other FIGS. can be implemented in association with the example presentation GUIs described above with respect to FIGS. 1 through 9.

Referring to FIG. 10, operation 1001 illustrates rendering a plurality of graphically movable objects that, when associated with a meeting on a calendar, automatically populates properties of the meeting with a predetermined meeting type and a duration. Operation 1001 may be followed by operation 1003. Operation 1003 illustrates receiving a gesture input indicative of a placement of a selected graphically movable object of the graphically movable objects on a calendar rendering on a user interface (UI), the calendar rendering comprising a representation of one or more calendar days having a plurality of time slots, the calendar rendering associated with a data structure storing data for meetings. Operation 1003 may be followed by operation 1005. Operation 1005 illustrates determining a start time for a scheduled meeting, wherein the start time for the scheduled meeting is based on a proximity of the placement of the selected graphically movable object relative to one of the time slots indicating the start time. Operation 1005 may be followed by operation 1007. Operation 1007 illustrates populating the data structure with one or more properties for the scheduled meeting, the one or more properties for the scheduled meeting populated with the start time, a determined date based on the start time, the predetermined meeting type, and the duration associated with the selected graphically movable object. Operation 1007 may be followed by operation 1009. Operation 1009 illustrates rendering a representation of the scheduled meeting in the calendar rendering in accordance with the populated data structure having the start time and the predetermined meeting type based on the properties of the selected graphically movable object, and wherein the populated data structure comprises the start time that is determined based on the proximity of the placement of the selected graphically movable object relative to one of the time slots indicating the start time.

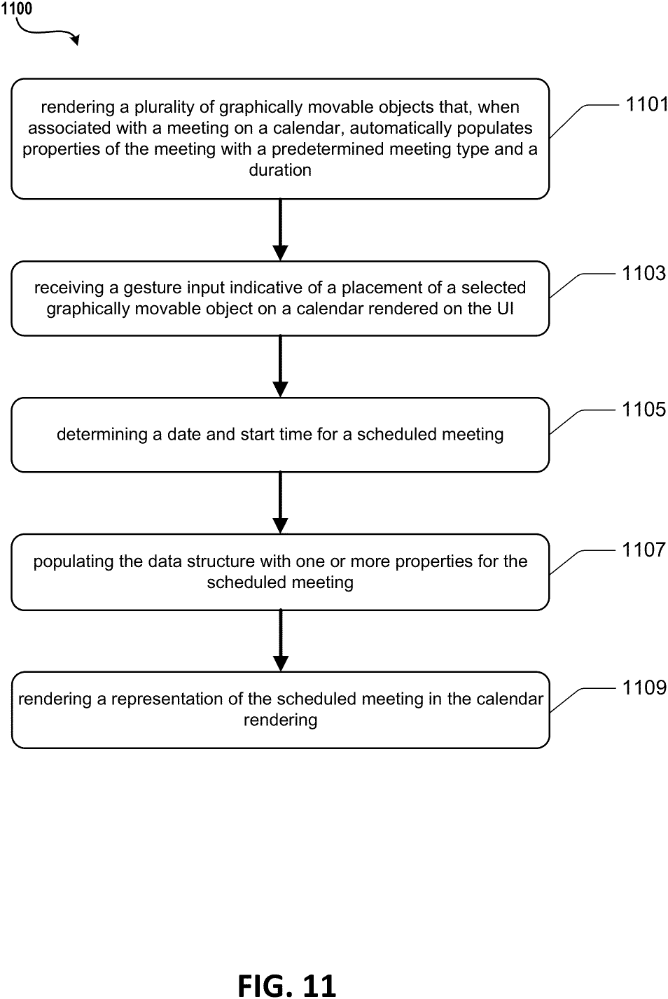

FIG. 11 is a diagram illustrating aspects of a routine 1100 for interacting with a rendered environment, according to one embodiment disclosed herein. Referring to FIG. 11, operation 1101 illustrates rendering, by a computing device on a user interface (UI), a plurality of graphically movable objects that, when associated with a meeting on a calendar, automatically populates properties of the meeting with a predetermined meeting type and a duration. Operation 1101 may be followed by operation 1103. Operation 1103 illustrates receiving a gesture input indicative of a placement of a selected graphically movable object on a calendar rendering on the UI, the calendar rendering comprising a representation of one or more calendar days having a plurality of time slots, the calendar rendering associated with a data structure storing data for meetings. Operation 1103 may be followed by operation 1105. Operation 1105 illustrates determining a date and start time for a scheduled meeting, wherein the date and start time for the scheduled meeting is based on a proximity of the placement of the selected graphically movable object relative to one of the time slots. Operation 1105 may be followed by operation 1107. Operation 1107 illustrates populating the data structure with one or more properties for the scheduled meeting, the one or more properties for the scheduled meeting populated with the determined date, the predetermined meeting type, and the duration associated with the selected graphically movable object. Operation 1109 illustrates rendering a representation of the scheduled meeting in the calendar rendering in accordance with the populated data structure having the start time and the predetermined meeting type based on the properties of the selected graphically movable object, and wherein the populated data structure comprises the start time that is determined based on the proximity of the placement of the selected graphically movable object relative to one of the time slots indicating the start time.

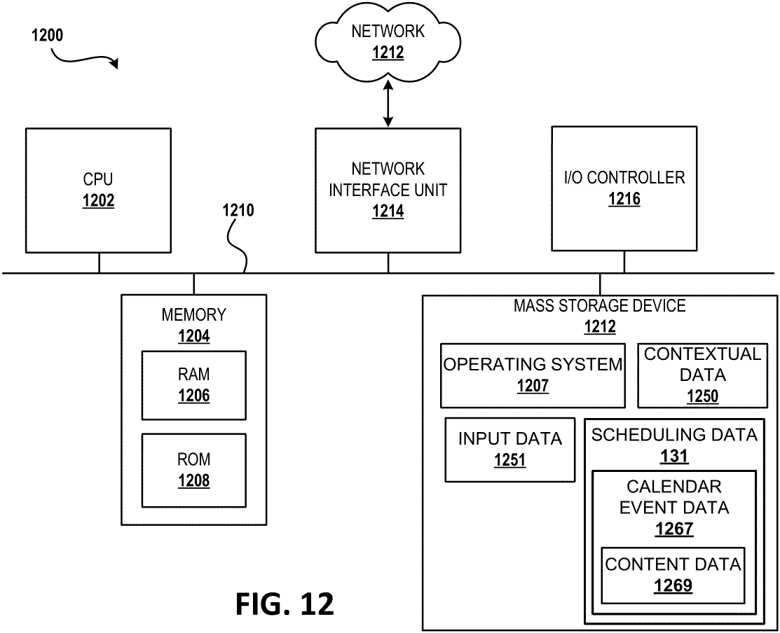

FIG. 12 shows additional details of an example computer architecture 1200 for a computer, such as any of the computing devices depicted in FIGS. 1-11, capable of executing the program components described herein. Thus, the computer architecture 1200 illustrated in FIG. 12 illustrates an architecture for a server computer, mobile phone, a PDA, a smart phone, a desktop computer, a netbook computer, a tablet computer, and/or a laptop computer. The computer architecture 1200 may be utilized to execute any aspects of the software components presented herein.

The computer architecture 1200 illustrated in FIG. 12 includes a central processing unit 1202 (“CPU”), a system memory 1204, including a random access memory 12012 (“RAM”) and a read-only memory (“ROM”) 1208, and a system bus 1210 that couples the memory 1204 to the CPU 1202. A basic input/output system containing the basic routines that help to transfer information between elements within the computer architecture 1200, such as during startup, is stored in the ROM 1208. The computer architecture 1200 further includes a mass storage device 1212 for storing an operating system 1207, data, such as the contextual data 1250, input data 1251, scheduling data 131, calendar event 1267, content data 1269, and one or more application programs (not depicted in FIG. 12).

The mass storage device 1212 is connected to the CPU 1202 through a mass storage controller (not shown) connected to the bus 1210. The mass storage device 1212 and its associated computer-readable media provide non-volatile storage for the computer architecture 1200. Although the description of computer-readable media contained herein refers to a mass storage device, such as a solid state drive, a hard disk or CD-ROM drive, it should be appreciated by those skilled in the art that computer-readable media can be any available computer storage media or communication media that can be accessed by the computer architecture 1200.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 1200. For purposes the claims, the phrase “computer storage medium,” “computer-readable storage medium” and variations thereof, does not include waves, signals, and/or other transitory and/or intangible communication media, per se.

According to various configurations, the computer architecture 1200 may operate in a networked environment using logical connections to remote computers through the network 7512 and/or another network (not shown). The computer architecture 1200 may connect to the network 7512 through a network interface unit 1214 connected to the bus 1210. It should be appreciated that the network interface unit 1214 also may be utilized to connect to other types of networks and remote computer systems. The computer architecture 1200 also may include an input/output controller 1216 for receiving and processing input from a number of other devices, including a keyboard, mouse, or electronic stylus (not shown in FIG. 12). Similarly, the input/output controller 1216 may provide output to a display screen, a printer, or other type of output device (also not shown in FIG. 12).

It should be appreciated that the software components described herein may, when loaded into the CPU 1202 and executed, transform the CPU 1202 and the overall computer architecture 1200 from a general-purpose computing system into a special-purpose computing system customized to facilitate the functionality presented herein. The CPU 1202 may be constructed from any number of transistors or other discrete circuit elements, which may individually or collectively assume any number of states. More specifically, the CPU 1202 may operate as a finite-state machine, in response to executable instructions contained within the software modules disclosed herein. These computer-executable instructions may transform the CPU 1202 by specifying how the CPU 1202 transitions between states, thereby transforming the transistors or other discrete hardware elements constituting the CPU 1202.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 1200 in order to store and execute the software components presented herein. It also should be appreciated that the computer architecture 1200 may include other types of computing devices, including hand-held computers, embedded computer systems, personal digital assistants, and other types of computing devices known to those skilled in the art. It is also contemplated that the computer architecture 1200 may not include all of the components shown in FIG. 12, may include other components that are not explicitly shown in FIG. 12, or may utilize an architecture completely different than that shown in FIG. 12.

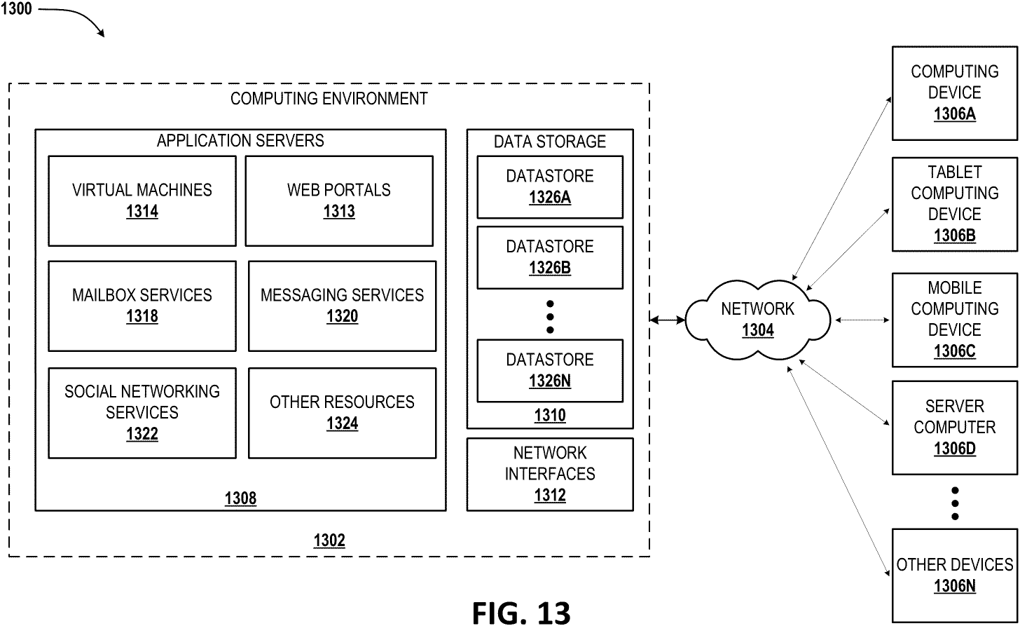

FIG. 13 depicts an illustrative distributed computing environment 1300 capable of executing the software components described herein for providing contextually-aware insights into calendar events. Thus, the distributed computing environment 1300 illustrated in FIG. 13 can be utilized to execute any aspects of the software components presented herein. For example, the distributed computing environment 1300 can be utilized to execute aspects of the software components described herein.

According to various implementations, the distributed computing environment 1300 includes a computing environment 1302 operating on, in communication with, or as part of the network 1304. The network 1304 may be or may include the network 1356, described above. The network 1304 also can include various access networks. One or more client devices 1306A-1306N (hereinafter referred to collectively and/or generically as “clients 1306”) can communicate with the computing environment 1302 via the network 1304 and/or other connections (not illustrated in FIG. 13). In one illustrated configuration, the clients 1306 include a computing device 1306A such as a laptop computer, a desktop computer, or other computing device; a slate or tablet computing device (“tablet computing device”) 1306B; a mobile computing device 1306C such as a mobile telephone, a smart phone, or other mobile computing device; a server computer 1306D; and/or other devices 1306N. It should be understood that any number of clients 1306 can communicate with the computing environment 1302. Two example computing architectures for the clients 1306 are illustrated and described herein with reference to FIGS. 1-15. It should be understood that the illustrated clients 1306 and computing architectures illustrated and described herein are illustrative, and should not be construed as being limited in any way.

In the illustrated configuration, the computing environment 1302 includes application servers 1308, data storage 1310, and one or more network interfaces 1312. According to various implementations, the functionality of the application servers 1308 can be provided by one or more server computers that are executing as part of, or in communication with, the network 1304. The application servers 1308 can host various services, virtual machines, portals, and/or other resources. In the illustrated configuration, the application servers 1308 host one or more virtual machines 1314 for hosting applications or other functionality. According to various implementations, the virtual machines 1314 host one or more applications and/or software modules for providing contextually-aware insights into calendar events. It should be understood that this configuration is illustrative, and should not be construed as being limiting in any way. The application servers 1308 also host or provide access to one or more portals, link pages, Web sites, and/or other information (“Web portals”) 1313.

According to various implementations, the application servers 1308 also include one or more mailbox services 1318 and one or more messaging services 1320. The mailbox services 1318 can include electronic mail (“email”) services. The mailbox services 1318 also can include various personal information management (“PIM”) services including, but not limited to, calendar services, contact management services, collaboration services, and/or other services. The messaging services 1320 can include, but are not limited to, instant messaging services, chat services, forum services, and/or other communication services.

The application servers 1308 also may include one or more social networking services 1322. The social networking services 1322 can include various social networking services including, but not limited to, services for sharing or posting status updates, instant messages, links, photos, videos, and/or other information; services for commenting or displaying interest in articles, products, blogs, or other resources; and/or other services. In some configurations, the social networking services 1322 are provided by or include the FACEBOOK social networking service, the LINKEDIN professional networking service, the MYSPACE social networking service, the FOURSQUARE geographic networking service, the YAMMER office colleague networking service, and the like. In other configurations, the social networking services 1322 are provided by other services, sites, and/or providers that may or may not be explicitly known as social networking providers. For example, some web sites allow users to interact with one another via email, chat services, and/or other means during various activities and/or contexts such as reading published articles, commenting on goods or services, publishing, collaboration, gaming, and the like. Examples of such services include, but are not limited to, the WINDOWS LIVE service and the XBOX LIVE service from Microsoft Corporation in Redmond, Washington. Other services are possible and are contemplated.

The social networking services 1322 also can include commenting, blogging, and/or micro blogging services. Examples of such services include, but are not limited to, the YELP commenting service, the KUDZU review service, the OFFICETALK enterprise micro blogging service, the TWITTER messaging service, the GOOGLE BUZZ service, and/or other services. It should be appreciated that the above lists of services are not exhaustive and that numerous additional and/or alternative social networking services 1322 are not mentioned herein for the sake of brevity. As such, the above configurations are illustrative, and should not be construed as being limited in any way. According to various implementations, the social networking services 1322 may host one or more applications and/or software modules for providing the functionality described herein for providing contextually-aware insights into calendar events. For instance, any one of the application servers 1308 may communicate or facilitate the functionality and features described herein. For instance, a social networking application, mail client, messaging client or a browser running on a phone or any other client 1306 may communicate with a networking service 1322 and facilitate the functionality, even in part, described above with respect to FIGS. 1-15.

As shown in FIG. 13, the application servers 1308 also can host other services, applications, portals, and/or other resources (“other resources”) 1324. The other resources 1324 can include, but are not limited to, document sharing, rendering or any other functionality. It thus can be appreciated that the computing environment 1302 can provide integration of the concepts and technologies disclosed herein provided herein with various mailbox, messaging, social networking, and/or other services or resources.

As mentioned above, the computing environment 1302 can include the data storage 1310. According to various implementations, the functionality of the data storage 1310 is provided by one or more databases operating on, or in communication with, the network 1304. The functionality of the data storage 1310 also can be provided by one or more server computers configured to host data for the computing environment 1302. The data storage 1310 can include, host, or provide one or more real or virtual data stores 1326A-1326N (hereinafter referred to collectively and/or generically as “datastores 1326”). The datastores 1326 are configured to host data used or created by the application servers 1308 and/or other data. Although not illustrated in FIG. 13, the datastores 1326 also can host or store web page documents, word documents, presentation documents, data structures, algorithms for execution by a recommendation engine, and/or other data utilized by any application program or another module. Aspects of the datastores 1326 may be associated with a service for storing files.

The computing environment 1302 can communicate with, or be accessed by, the network interfaces 1312. The network interfaces 1312 can include various types of network hardware and software for supporting communications between two or more computing devices including, but not limited to, the clients 1306 and the application servers 1308. It should be appreciated that the network interfaces 1312 also may be utilized to connect to other types of networks and/or computer systems.

It should be understood that the distributed computing environment 1300 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 1300 provides the software functionality described herein as a service to the clients 1306. It should be understood that the clients 1306 can include real or virtual machines including, but not limited to, server computers, web servers, personal computers, mobile computing devices, smart phones, and/or other devices. As such, various configurations of the concepts and technologies disclosed herein enable any device configured to access the distributed computing environment 1300 to utilize the functionality described herein for providing contextually-aware insights into calendar events, among other aspects.

It should be appreciated that the above-described subject matter may be implemented as a computer-controlled apparatus, a computer process, a computing system, or as an article of manufacture such as a computer-readable storage medium. The operations of the example methods are illustrated in individual blocks and summarized with reference to those blocks. The methods are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations.

Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) such as one or more internal or external CPUs or GPUs, and/or one or more pieces of hardware logic such as field-programmable gate arrays (“FPGAs”), digital signal processors (“DSPs”), or other types of accelerators.

All of the methods and processes described above may be embodied in, and fully automated via, software code modules executed by one or more general purpose computers or processors. The code modules may be stored in any type of computer-readable storage medium or other computer storage device, such as those described below. Some or all of the methods may alternatively be embodied in specialized computer hardware, such as that described below.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art.

It is to be appreciated that conditional language used herein such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

It should be also be appreciated that many variations and modifications may be made to the above-described examples, the elements of which are to be understood as being among other acceptable examples. All such modifications and variations are intended to be included herein within the scope of this disclosure and protected by the following claims.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

Among many other technical benefits, the technologies herein enable more efficient use of computing resources such as processor cycles, memory, network bandwidth, and power, as compared to previous solutions relying upon inefficient manual placement of virtual objects in a 3D environment. Other technical benefits not specifically mentioned herein can also be realized through implementations of the disclosed subject matter.

Although the techniques have been described in language specific to structural features and/or methodological acts, it is to be understood that the appended claims are not necessarily limited to the features or acts described. Rather, the features and acts are described as example implementations of such techniques.

### EXAMPLE CLAUSES

The disclosure presented herein encompasses the subject matter set forth in the following example clauses.

Example Clause A, a system comprising:
one or more data processing units; and
a computer-readable medium having encoded thereon computer-executable instructions to cause the one or more data processing units to:
render a plurality of graphically movable objects that, when associated with a meeting on a calendar, automatically populates properties of the meeting with a predetermined meeting type and a duration;
receive a gesture input indicative of a placement of a selected graphically movable object of the graphically movable objects on a calendar rendering on a user interface (UI), the calendar rendering comprising a representation of one or more calendar days having a plurality of time slots, the calendar rendering associated with a data structure storing data for meetings;
determine a start time for a scheduled meeting, wherein the start time for the scheduled meeting is based on a proximity of the placement of the selected graphically movable object relative to one of the time slots indicating the start time;
populate the data structure with one or more properties for the scheduled meeting, the one or more properties for the scheduled meeting populated with the start time, a determined date based on the start time, the predetermined meeting type, and the duration associated with the selected graphically movable object; and
render a representation of the scheduled meeting in the calendar rendering in accordance with the populated data structure having the start time and the predetermined meeting type based on the properties of the selected graphically movable object, and wherein the populated data structure comprises the start time that is determined based on the proximity of the placement of the selected graphically movable object relative to one of the time slots indicating the start time.

Example Clause B, the system of Example Clause A, wherein the instructions further cause the one or more data processing units to:

render a window usable to receive, via the UI, meeting details for the scheduled meeting; wherein the window includes prepopulated data fields indicating the determined, start time, predetermined meeting type, and duration in accordance with the selected graphically movable object.

Example Clause C, the system of any one of Example Clauses A through B, wherein the duration for the graphically movable objects includes 15 minutes, 30 minutes, and 1 hour.

Example Clause D, the system of any one of Example Clauses A through C, wherein the graphically movable objects are stored as data objects excluding a start time or date.

Example Clause E, the system of any one of Example Clauses A through D, wherein the predetermined meeting type for the graphically movable objects includes a meeting with preparation time, and a meeting with follow up time.

Example Clause F, the system of any one of Example Clauses A through E, wherein the predetermined meeting type for the graphically movable objects includes an organization meeting, and a working meeting.

Example Clause G, the system of any one of Example Clauses A through F, wherein:
the graphically movable objects are rotatable; and
an existing meeting is canceled when a matching graphically movable object is rotated and placed proximate to the existing meeting.

Example Clause H, the system of any one of Example Clauses A through G, wherein the calendar is rendered on the user interface in response to a prompt to create a calendar entry from another application.

Example Clause I, the system of any one of Example Clauses A through H, wherein the graphically movable objects are associated with data objects that include the predetermined meeting type and a duration for each graphically movable object, and the data structure is populated based on data contained in the data objects when a scheduled meeting is created.

While Example Clauses A through I are described above with respect to a system, it is understood in the context of this disclosure that the subject matter of Example Clauses A through I can additionally or alternatively be implemented by a method or device.

Example Clause J, a method to be performed by a data processing system, the method comprising:
rendering, by a computing device on a user interface (UI), a plurality of graphically movable objects that, when associated with a meeting on a calendar, automatically populates properties of the meeting with a predetermined meeting type and a duration;
receiving a gesture input indicative of a placement of a selected graphically movable object on a calendar rendering on the UI, the calendar rendering comprising a representation of one or more calendar days having a plurality of time slots, the calendar rendering associated with a data structure storing data for meetings;
determining a date and start time for a scheduled meeting, wherein the date and start time for the scheduled meeting is based on a proximity of the placement of the selected graphically movable object relative to one of the time slots;
populating the data structure with one or more properties for the scheduled meeting, the one or more properties for the scheduled meeting populated with the determined date, the predetermined meeting type, and the duration associated with the selected graphically movable object; and
rendering a representation of the scheduled meeting in the calendar rendering in accordance with the populated data structure having the start time and the predetermined meeting type based on the properties of the selected graphically movable object, and wherein the populated data structure comprises the start time that is determined based on the proximity of the placement of the selected graphically movable object relative to one of the time slots indicating the start time.

Example Clause K, the method of Example Clause J further comprising:

rendering a window usable to receive, via the UI, meeting details for the scheduled meeting; wherein the window includes prepopulated data fields indicating the determined, start time, predetermined meeting type, and duration in accordance with the selected graphically movable object.

Example Clause L, the method of any one of Example Clauses I through K, wherein the duration for the graphically movable objects includes 15 minutes, 30 minutes, and 1 hour.

Example Clause M, the method of any one of Example Clauses I through L, wherein the graphically movable objects are stored as data objects excluding a start time or date.

Example Clause N, the method of any one of Example Clauses I through M, wherein the predetermined meeting type for the graphically movable objects includes a meeting with preparation time, and a meeting with follow up time.

Example Clause O, the method of any one of Example Clauses I through N, wherein the predetermined meeting type for the graphically movable objects includes an organization meeting, and a working meeting.

Example Clause P, the method of any one of Example Clauses I through O, wherein the graphically movable objects are predetermined based on one or more of a user role, user option, or an administrator setting.

While Example Clauses J through P are described above with respect to a method, it is understood in the context of this disclosure that the subject matter of Example Clauses J through P can additionally or alternatively be implemented by a system or device.

Example Clause Q, a system, comprising:
means for rendering a plurality of graphically movable objects that, when associated with a meeting on a calendar, automatically populates properties of the meeting with a predetermined meeting type and a duration;
means for receiving a gesture input indicative of a placement of a selected graphically movable object on a calendar rendered on the UI, the calendar comprising a representation of one or more calendar days having a plurality of time slots, the calendar rendering associated with a data structure storing data for meetings;
means for determining a date and start time for a scheduled meeting, wherein the date and start time for the scheduled meeting is based on a proximity of the placement of the selected graphically movable object relative to one of the time slots indicating the start time;
means for populating the data structure with one or more properties for the scheduled meeting, the one or more properties for the scheduled meeting populated with the determined date, the determined start time, the predetermined meeting type, and the duration associated with the selected graphically movable object; and
means for rendering a representation of the scheduled meeting in the calendar rendering in accordance with the populated data structure having the start time and the predetermined meeting type based on the properties of the selected graphically movable object, and wherein the populated data structure comprises the start time that is determined based on the proximity of the placement of the selected graphically movable object relative to one of the time slots indicating the start time.

Example Clause R, the system of Example Clause Q, wherein the calendar is rendered on the user interface in response to a prompt to create a calendar entry from another application.

Example Clause S, the system of any of Example Clauses Q through R, wherein the graphically movable objects are associated with data objects that include the predetermined meeting type and a duration for each graphically movable object, and the data structure is populated based on data contained in the data objects when a scheduled meeting is created.

Example Clause T, the system of any one of Example Clauses Q through S, further comprising:

means for rendering a window usable to receive, via the UI, meeting details for the scheduled meeting; wherein the window includes prepopulated data fields indicating the determined, start time, predetermined meeting type, and duration in accordance with the selected graphically movable object.

While Example Clauses Q through T are described above with respect to a system, it is understood in the context of this disclosure that the subject matter of Example Clauses Q through T can additionally or alternatively be implemented by a method or via a device.

What is claimed is:

1. A system comprising:
one or more data processing units; and
a computer-readable medium having encoded thereon computer-executable instructions to cause the one or more data processing units to:
render a plurality of graphically movable objects that, when associated with a meeting on a calendar, automatically populates properties of the meeting with a predetermined meeting type and a duration;
receive a gesture input indicative of a placement of a selected graphically movable object of the graphically movable objects on a calendar rendering on a user interface (UI), the calendar rendering comprising a representation of one or more calendar days having a plurality of time slots, the calendar rendering associated with a data structure storing data for meetings;
determine a start time for a scheduled meeting, wherein the start time for the scheduled meeting is based on a proximity of the placement of the selected graphically movable object relative to one of the time slots indicating the start time;
populate the data structure with one or more properties for the scheduled meeting, the one or more properties for the scheduled meeting populated with the start time, a determined date based on the start time, the predetermined meeting type, and the duration associated with the selected graphically movable object; and
render a representation of the scheduled meeting in the calendar rendering in accordance with the populated data structure having the start time and the predetermined meeting type based on the properties of the selected graphically movable object, and wherein the populated data structure comprises the start time that is determined based on the proximity of the placement of the selected graphically movable object relative to one of the time slots indicating the start time.

2. The system of claim 1, wherein the instructions further cause the one or more data processing units to:
render a window usable to receive, via the UI, meeting details for the scheduled meeting; wherein the window includes prepopulated data fields indicating the determined, start time, predetermined meeting type, and duration in accordance with the selected graphically movable object.

3. The system of claim 1, wherein the duration for the graphically movable objects includes 15 minutes, 30 minutes, and 1 hour.

4. The system of claim 1, wherein the graphically movable objects are stored as data objects excluding a start time or date.

5. The system of claim 1, wherein the predetermined meeting type for the graphically movable objects includes a meeting with preparation time, and a meeting with follow up time.

6. The system of claim 1, wherein the predetermined meeting type for the graphically movable objects includes an organization meeting, and a working meeting.

7. The system of claim 1, wherein:
the graphically movable objects are rotatable; and
an existing meeting is canceled when a matching graphically movable object is rotated and placed proximate to the existing meeting.

8. The system of claim 1, wherein the calendar is rendered on the user interface in response to a prompt to create a calendar entry from another application.

9. The system of claim 1, wherein the graphically movable objects are associated with data objects that include the predetermined meeting type and a duration for each graphically movable object, and the data structure is populated based on data contained in the data objects when a scheduled meeting is created.

10. A method to be performed by a data processing system, the method comprising:
rendering, by a computing device on a user interface (UI), a plurality of graphically movable objects that, when associated with a meeting on a calendar, automatically populates properties of the meeting with a predetermined meeting type and a duration;
receiving a gesture input indicative of a placement of a selected graphically movable object on a calendar rendering on the UI, the calendar rendering comprising a representation of one or more calendar days having a plurality of time slots, the calendar rendering associated with a data structure storing data for meetings;
determining a date and start time for a scheduled meeting, wherein the date and start time for the scheduled meeting is based on a proximity of the placement of the selected graphically movable object relative to one of the time slots;
populating the data structure with one or more properties for the scheduled meeting, the one or more properties for the scheduled meeting populated with the determined date, the predetermined meeting type, and the duration associated with the selected graphically movable object; and
rendering a representation of the scheduled meeting in the calendar rendering in accordance with the populated data structure having the start time and the predetermined meeting type based on the properties of the selected graphically movable object, and wherein the populated data structure comprises the start time that is determined based on the proximity of the placement of the selected graphically movable object relative to one of the time slots indicating the start time.

11. The method of claim 10, further comprising:
rendering a window usable to receive, via the UI, meeting details for the scheduled meeting; wherein the window includes prepopulated data fields indicating the determined, start time, predetermined meeting type, and duration in accordance with the selected graphically movable object.

12. The method of claim 10, wherein the duration for the graphically movable objects includes 15 minutes, 30 minutes, and 1 hour.

13. The method of claim 10, wherein the graphically movable objects are stored as data objects excluding a start time or date.

14. The method of claim 10, wherein the predetermined meeting type for the graphically movable objects includes a meeting with preparation time, and a meeting with follow up time.

15. The method of claim 10, wherein the predetermined meeting type for the graphically movable objects includes an organization meeting, and a working meeting.

16. The method of claim 10, wherein the graphically movable objects are predetermined based on one or more of a user role, user option, or an administrator setting.

17. A system, comprising:
means for rendering a plurality of graphically movable objects that, when associated with a meeting on a calendar, automatically populates properties of the meeting with a predetermined meeting type and a duration;
means for receiving a gesture input indicative of a placement of a selected graphically movable object on a calendar rendered on the UI, the calendar comprising a representation of one or more calendar days having a plurality of time slots, the calendar rendering associated with a data structure storing data for meetings;
means for determining a date and start time for a scheduled meeting, wherein the date and start time for the scheduled meeting is based on a proximity of the placement of the selected graphically movable object relative to one of the time slots indicating the start time;
means for populating the data structure with one or more properties for the scheduled meeting, the one or more properties for the scheduled meeting populated with the determined date, the determined start time, the predetermined meeting type, and the duration associated with the selected graphically movable object; and
means for rendering a representation of the scheduled meeting in the calendar rendering in accordance with the populated data structure having the start time and the predetermined meeting type based on the properties of the selected graphically movable object, and wherein the populated data structure comprises the start time that is determined based on the proximity of the placement of the selected graphically movable object relative to one of the time slots indicating the start time.

18. The system of claim 17, wherein the calendar is rendered on the user interface in response to a prompt to create a calendar entry from another application.

19. The system of claim 17, wherein the graphically movable objects are associated with data objects that include the predetermined meeting type and a duration for each graphically movable object, and the data structure is populated based on data contained in the data objects when a scheduled meeting is created.

20. The system of claim 17, further comprising:
means for rendering a window usable to receive, via the UI, meeting details for the scheduled meeting; wherein the window includes prepopulated data fields indicating the determined, start time, predetermined meeting type, and duration in accordance with the selected graphically movable object.
